(19) United States
(12) Patent Application Publication
(10) Pub. No.: US 2019/0227762 A1
(43) Pub. Date: Jul. 25, 2019

(54) INFORMATION PROCESSING DEVICE, DISPLAY DEVICE, METHOD FOR CONTROLLING INFORMATION PROCESSING DEVICE, AND INFORMATION PROCESSING PROGRAM

(71) Applicant: SHARP KABUSHIKI KAISHA, Sakai City, Osaka (JP)

(72) Inventors: MASAAKI MORIYA, Sakai City (JP); MASAFUMI UENO, Sakai City (JP); NAOKI SHIOBARA, Sakai City (JP); YASUHIRO SUGITA, Sakai City (JP)

(21) Appl. No.: 16/313,012

(22) PCT Filed: Mar. 28, 2017
(86) PCT No.: PCT/JP2017/012596

§ 371 Date: Dec. 22, 2018

(30) Foreign Application Priority Data
Jun. 27, 2016 (JP) 2016-126901

(51) Int. Cl. G06F 3/14; H04W 4/80; G06K 7/10

(52) U.S. Cl. CPC G06F 3/14; G06F 3/044; G06K 7/10297; H04W 4/80

(57) ABSTRACT

The present disclosure executes various types of processing by means of simple operations and processing. An information processing device includes a terminal information acquisition circuit acquiring identification information from an NFC terminal via an NFC antenna; a position determination circuit determining whether or not a terminal position corresponds to at least one prescribed position determined in advance; and a processing permission circuit permitting prescribed processing in a case where the identification information satisfies a prescribed condition and the terminal position is determined to correspond to the prescribed position.

### CROSS-REFERENCE TO RELATED APPLICATIONS

This application claims the benefit of priority to Japanese Patent Application Number 2016-126901 filed on Jun. 27, 2016. The entire contents of the above-identified application are hereby incorporated by reference.

### TECHNICAL FIELD

One aspect of the present disclosure relates to a display device including an antenna, an information processing device communicable with an information terminal, and the like.

### BACKGROUND ART

In recent years, various types of services by performing data communication with use of near field radio communication such as Near Field Communication (NFC) have been developed. An example of related technique is disclosed in PTL 1.

PTL 1 discloses an information providing device that receives identification information from a user terminal by performing data communication with use of NFC, and outputs recommend information, based on a use history of the user terminal stored in association with received identification information.

### CITATION LIST

### Patent Literature

PTL 1: JP 2014-175897 A (published on Sep. 22, 2014)

### SUMMARY OF INVENTION

### Technical Problem

An object of one aspect of the present disclosure is to provide an information processing device and the like being capable of executing various types of processing by means of simple operations and processing regarding an information processing device that acquires identification information from a user terminal.

### Solution to Problem

In order to solve the above-described problem, an information processing device according to one aspect of the present disclosure is an information processing device cooperative with a display device including an antenna stacked on a display body, and communicable with an information terminal, the information processing device including: an identification information acquisition circuit acquiring identification information stored in the information terminal and identifying the information terminal or a user, from the information terminal via the antenna; a position determination circuit determining whether or not a terminal position being a position where the information terminal comes in proximity to or comes into contact with the display body corresponds to at least one prescribed position determined in advance; and a processing permission circuit permitting prescribed processing in a case where a first condition is satisfied, the first condition being that the identification information acquired by the identification information acquisition circuit satisfies a prescribed condition and the position determination circuit determines that the terminal position corresponds to the prescribed position.

Moreover, in order to solve the above-described problem, a method for controlling an information processing device according to one aspect of the present disclosure is a method for controlling an information processing device cooperative with a display device including an antenna stacked on a display body, and communicable with an information terminal, the method including: an identification information acquisition step of acquiring identification information stored in the information terminal and identifying the information terminal or a user, from the information terminal via the antenna; a position determination step of determining whether or not a terminal position being a position where the information terminal comes in proximity to or comes into contact with the display body corresponds to at least one prescribed position determined in advance; and a processing permission step of permitting prescribed processing in a case where a first condition is satisfied, the first condition being that the identification information acquired by the identification information acquisition step satisfies a prescribed condition and the position determination step determines that the terminal position corresponds to the prescribed position.

### Advantageous Effects of Invention

An information processing device according to one aspect of the present disclosure produces an advantageous effect that various types of processing can be executed by means of simple operations and processing.

Further, a method for controlling an information processing device according to one aspect of the present disclosure also produces a similar advantageous effect.

### BRIEF DESCRIPTION OF DRAWINGS

FIG. 1 is a functional block diagram illustrating a configuration of main components of an information processing system according to a first embodiment.

FIG. 2 is a diagram exemplifying a configuration of an NFC display in the information processing system in FIG. 1.

FIGS. 3A and 3B are diagrams for describing the principles of a touch panel in the information processing system illustrated in FIG. 1, and FIGS. 3C and 3D are diagrams illustrating an example of a sensor signal generated in a case where a body comes into contact with the above-described touch panel.

FIG. 4 is a diagram illustrating an arrangement example of NFC antennas in the NFC display in FIG. 1.

FIG. 5 is a diagram illustrating an example of a game screen to be displayed on the NFC display in FIG. 4, and is a diagram illustrating a state before a user holds an NFC terminal above.

FIG. 6 is a diagram illustrating an example of the above-described game screen, and is a diagram illustrating a case that a user holds an NFC terminal above and acquires a coupon.

FIG. 7 is a diagram illustrating an example of the above-described game screen, and is a diagram illustrating a state that a user holds the NFC terminal above again following the state in FIG. 6.

FIG. 8 is a diagram illustrating classification of processing of an information processing device in a game provided in the information processing system according to the first embodiment.

FIG. 9 is a diagram illustrating an example of processing in the information processing device according to the first embodiment.

FIG. 10 is a functional block diagram illustrating a configuration of main components of an information processing system according to a second embodiment.

FIG. 11 is a diagram illustrating an example of processing in an information processing device according to the second embodiment.

FIG. 12 is a diagram illustrating an arrangement example of NFC antennas in an information processing system according to a third embodiment.

FIG. 13 is a diagram illustrating classification of processing of an information processing device in a game provided in the information processing system according to the third embodiment.

FIG. 14 is a diagram illustrating an example of processing in the information processing device according to the third embodiment.

### DESCRIPTION OF EMBODIMENTS

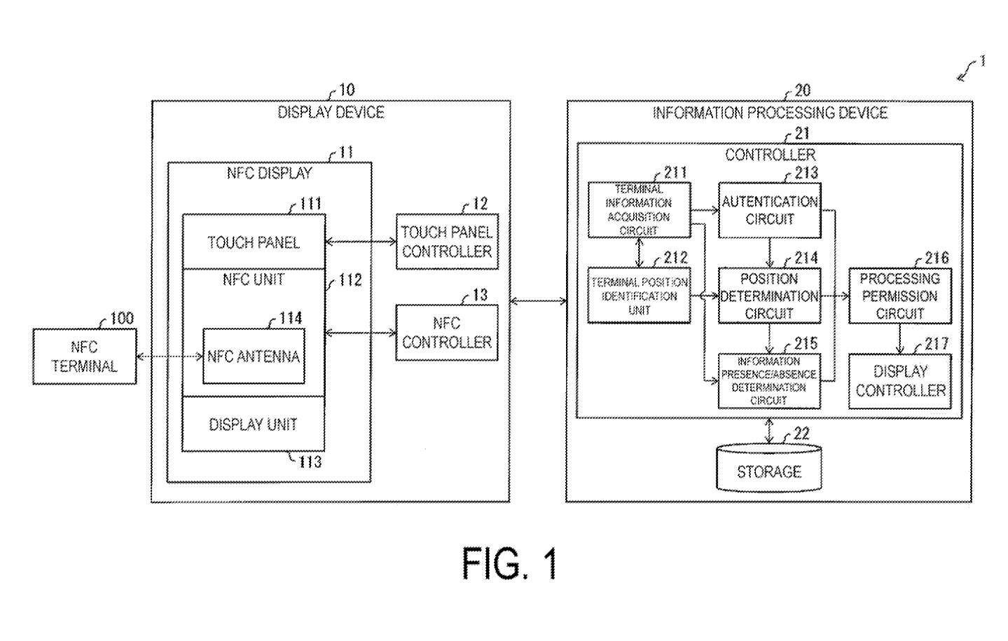

In the following respective embodiments, an example of data processing using near field radio communication is described, based on FIG. 1 to FIG. 14.

Note that near field radio communication indicates general radio communication with a short reaching distance. Near field radio communication includes communication using a Radio Frequency IDentification (RFID) technique such as a non-contact Integrated Circuit (IC) card or a non-contact IC tag, for example. In the present embodiment, unless otherwise specifically mentioned, a wording “communication” may be interpreted to mean near field radio communication. In the following embodiments, description is made by exemplifying NFC as an example of near field radio communication.

### First Embodiment

First of all, an information processing system 1 according to a first embodiment of the present disclosure is described in detail, based on FIG. 1 to FIG. 9.

### Information Processing System 1

First, an overview of the information processing system 1 is described with reference to FIG. 1. FIG. 1 is a functional block diagram illustrating a configuration of main components of the information processing system 1 in the present embodiment.

The information processing system 1 includes a display device 10 and an information processing device 20. FIG. 1 exemplifies, in the information processing system 1, a configuration in which the display device 10 and the information processing device 20 are provided as individual devices. In such a configuration, the display device 10 and the information processing device 20 transmit and/or receive information via a transmission and/or reception unit (not illustrated). Note that information transmission and/or reception between the display device 10 and the information processing device 20 may be performed either by wired or wireless communication. Further, the display device 10 and the information processing device 20 may transmit and/or receive information via a relay device such as a router.

Alternatively, in the information processing system 1, the display device 10 and the information processing device 20 may be provided as an integral unit. Specifically, the display device 10 may be configured to include the information processing device 20.

### Display Device 10

The display device 10 is a device that displays an image, and includes an NFC display 11, a touch panel controller 12, and an NFC controller 13. The display device 10 may be used as a digital signage, for example.

The NFC display 11 is a display having a function of performing near field radio communication with an NFC terminal 100 (information terminal). Note that a type of an NFC terminal 100 is not specifically limited, as far as the NFC terminal 100 is communicable with an NFC antenna 114 to be described later. As an example, an NFC terminal 100 may be (i) an NFC card, (ii) a body to which an NFC tag is attached, or (iii) a mobile terminal (also referred to as an NFC-mounted mobile terminal) having an NFC function.

Note that, in the present embodiment and other embodiments, an “NFC card” may be simply referred to as a “card”.

The NFC display 11 includes a touch panel 111 (touch sensor), an NFC unit 112 (an antenna layer or an antenna sheet), and a display unit 113 (a display screen or a display body). Note that, in the NFC display 11, the touch panel 111 can recognize multi-touch such as ten-point touch, for example. Therefore, the NFC display 11 is able to receive input operations (touch operations) by a plurality of users.

In the present embodiment, description is made by exemplifying a case that the display unit 113 is a display screen capable of switching a display image. However, a display body according to one aspect of the present disclosure is not limited to this example. As an example, the display body may be a billboard that does not have a function of switching a display image.

Further, in the present embodiment, description is made by exemplifying a case that each member of the NFC display 11 has a flat shape (rectangular shape). However, in a case where each member of the NFC display 11 is made of a flexible material, it is also possible to configure the NFC display 11 having a curved surface by using a well-known freeform display technique, and the like. For example, it is also possible to provide the NFC display 11 on a lateral surface of a tubular structure (support member).

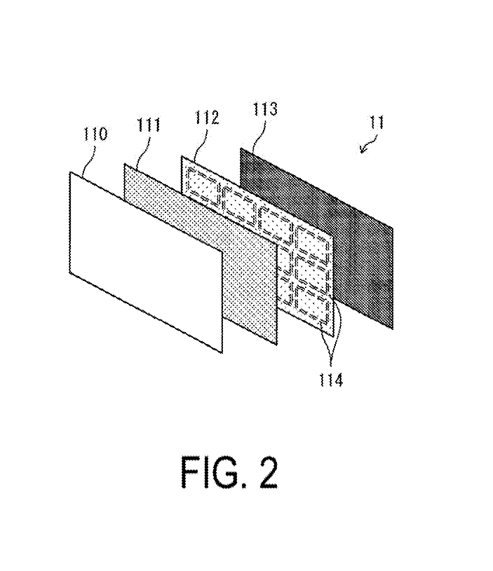

FIG. 2 is a diagram exemplifying a configuration of the NFC display 11. In the following, a specific configuration of the NFC display 11 is described with reference to FIG. 2. The NFC display 11 is configured such that respective members are stacked in an order of a protective glass 110, the touch panel 111, the NFC unit 112, and the display unit 113 from a side where a viewer views an image.

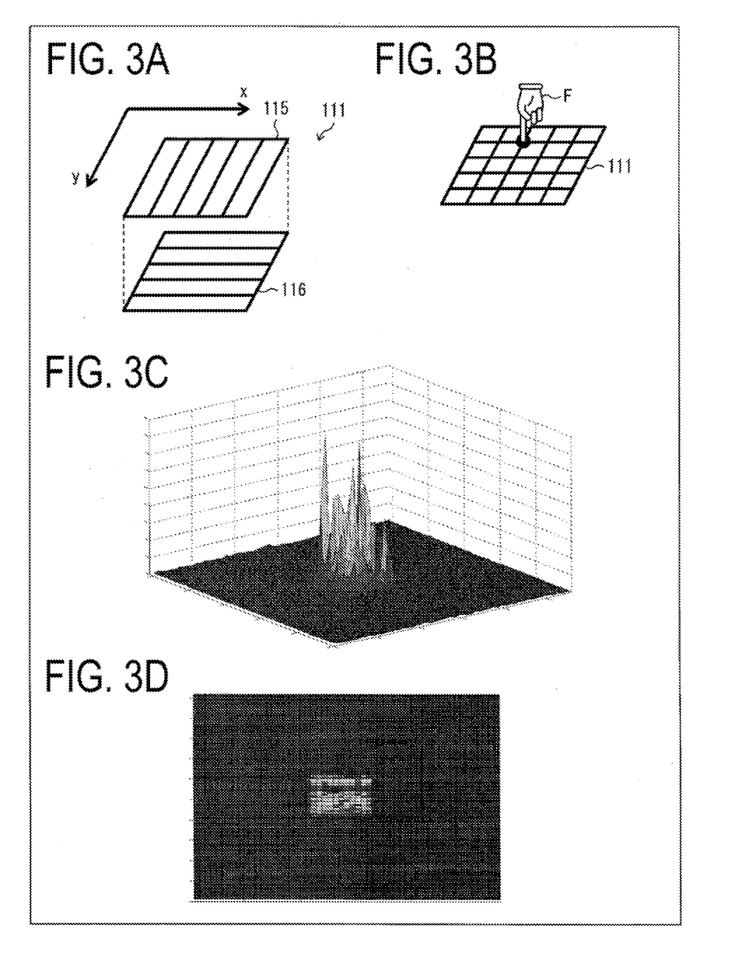

The touch panel 111 has a function of detecting proximity or contact of a body. In the present embodiment, description is made by exemplifying a case that the touch panel 111 is a capacitive touch panel. In the following, the touch panel 111 is described with reference to FIGS. 3A to 3D.

FIGS. 3A and 3B are diagrams for describing the principles of the touch panel 111. FIGS. 3C and 3D are diagrams illustrating an example of a sensor signal generated in a case where a body comes into contact with the touch panel 111. The sensor signal is a signal indicating a distribution of capacitance on the touch panel 111. Note that, in the following, description is made by exemplifying the case that a body comes into contact with the touch panel 111, but a case that the body comes in proximity to the touch panel 111 can be similarly described.

As illustrated in FIG. 3A, the touch panel 111 is formed by stacking a transparent electrode 115 extending in a Y-direction and a transparent electrode 116 extending in an X-direction (e.g., a direction perpendicular to the Y-direction). Further, as illustrated in FIG. 3B, in a case where a body having conductivity (e.g., a finger F in FIG. 3B) comes into contact with the touch panel 111, the capacitance changes. Therefore, it is possible to identify a position on the touch panel 111 where a body comes into contact by detecting a position (coordinates) on the touch panel 111 where the capacitance changes.

FIGS. 3C and 3D are diagrams illustrating an example of the sensor signal in a case where an NFC card as the NFC terminal 100 is brought into contact with the touch panel 111. Note that the above-described NFC card includes an antenna coil (NFC antenna) configured to implement a near field radio communication function, and the touch panel 111 is able to detect contact of the NFC card by conductivity of the antenna coil.

In a case where the NFC card is brought into contact with the touch panel 111, the sensor signal illustrated in FIG. 3C is generated on the touch panel 111. In a case where this phenomenon is illustrated by a top view, as illustrated in FIG. 3D, it can be seen that the sensor signal of a shape similar to the shape of a contact surface of the NFC card (surface in contact with the touch panel 111) is generated.

More specifically, the sensor signal of a shape corresponding to the shape of an antenna coil provided on the NFC card is generated on the touch panel 111. Note that, in a case where the NFC card itself is made of a conductive material, the sensor signal of a shape corresponding to the shape of the NFC card is generated on the touch panel 111.

The touch panel 111 outputs signal information indicating the sensor signal to the touch panel controller 12. Specifically, the touch panel 111 outputs the signal information to the touch panel controller 12 at a frequency of from 60 to 240 times per second.

The touch panel controller 12 (see FIG. 1) is a member that integrally controls operations of the touch panel 111, and also functions as an information processing unit (signal information processing unit) that processes the signal information. Specifically, the touch panel controller 12 analyzes the signal information, and identifies the position on the touch panel 111 where a body comes into contact. Further, the touch panel controller 12 transmits position information indicating the position to a control unit 21 to be described later.

Note that, although not illustrated in FIGS. 3A to 3D, in a case where a body having a small contact area such as the finger F comes into contact with the touch panel 111, a wide range sensor signal (in other words, a broad sensor signal) illustrated in FIG. 3C is not generated, but a narrow range sensor signal (in other words, a narrow sensor signal) is generated.

Note that, in the above-described description, a capacitive touch panel 111 is exemplified. However, a type (operation principles) of the touch panel 111 is not limited only to a capacitive type. As an example, a type of the touch panel 111 may be of a method using an infrared sensor (optical sensor), or a method using a pressure sensitive sensor.

Further, as described above, the touch panel 111 may output, as the signal information, a state that a body is not in direct contact with the touch panel 111 and is in proximity to the touch panel 111, specifically, a distribution of capacitance generated by hover touch. In this way, a touch panel (touch sensor) according to one aspect of the present disclosure may be any type as long as a function of detecting proximity or contact of a body is provided.

Referring back to FIG. 2, the NFC unit 112 is a communication device configured to perform near field radio communication with the NFC terminal 100. The NFC unit 112 is an antenna module including NFC antennas 114 (antennas). Each NFC antenna 114 is a transparent antenna having a function of detecting the NFC terminal 100 and transmitting and/or receiving information. The NFC antenna 114 may be used as a tag reader, for example.

The NFC controller 13 (see FIG. 1) is a member that controls operations of the NFC antenna 114. The NFC controller 13 is able to (i) read information from the NFC terminal 100, and (ii) write information in the NFC terminal 100, via the NFC antenna 114, based on a control signal from the control unit 21 to be described later. Therefore, the NFC controller 13 is also referred to as an NFC reader/writer.

The NFC controller 13 is able to acquire terminal information from the NFC terminal 100, and transmit the terminal information to the control unit 21. Further, the NFC controller 13 is also able to transmit, to the control unit 21, an antenna ID of an NFC antenna 114 that has performed communication in the acquisition of the above-described terminal information. Note that the antenna ID is a unique identification number allocated to each NFC antenna 114 in advance in order to identify each of the NFC antennas 114.

Note that, as illustrated in FIG. 2, the NFC unit 112 is a sheet-shaped member provided in between the touch panel 111 and the display unit 113. In the example of FIG. 2, three NFC antennas 114 in a vertical direction (short side direction of the NFC unit 112) and four NFC antennas 114 in a horizontal direction (long side direction of the NFC unit 112) (twelve NFC antennas 114 in total) are uniformly provided in the NFC unit 112.

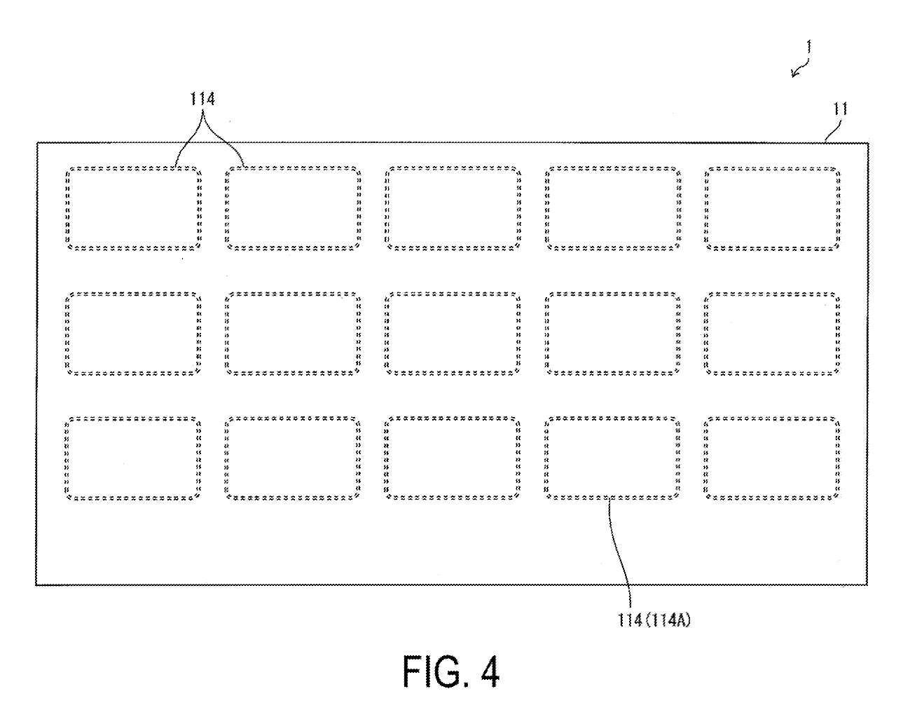

However, the number and the layout of NFC antennas 114 provided in the NFC unit 112 are not limited to the example in FIG. 2. For example, three NFC antennas 114 in the vertical direction, and five NFC antennas 114 in the horizontal direction may be provided in the NFC unit 112 (see FIG. 4 to be described later). Alternatively, the NFC antennas 114 may be provided only at four corners of the NFC unit 112. Further alternatively, only one NFC antenna 114 may be provided at an end of the NFC unit 112, for example.

In the NFC display 11, a position where the NFC unit 112 is provided is also not limited to the example in FIG. 2. For example, the NFC antennas 114 may be provided in the touch panel 111. Specifically, the touch panel 111 and the NFC unit 112 may be integrally formed. In the present embodiment, the NFC antennas 114 may be disposed over the display unit 113 (a display screen or a display body).

By designating the above-described antenna ID(s), the NFC unit 112 may (i) drive (successively drive) a plurality of NFC antennas 114 in a certain order, or (ii) drive only a specific NFC antenna(s) of a plurality of NFC antennas 114.

The display unit 113 is a display device that displays various types of images. The display unit 113 is able to display, as an image, each piece of information supplied from the information processing device 20 to be described in the following. The display unit 113 is a Liquid Crystal Display (LCD), for example, but is not limited to this example. Further, the display unit 113 may include a backlight.

According to the configuration of the display device 10, a user is allowed to cause the NFC terminal 100 to communicate with the NFC antenna 114 by holding the NFC terminal 100 owned by the user above the NFC antenna 114. Therefore, in the information processing device 20 to be described later, it is possible to perform authentication based on various types of information included in the above-described terminal information (e.g., identification information to be described in the following), for example.

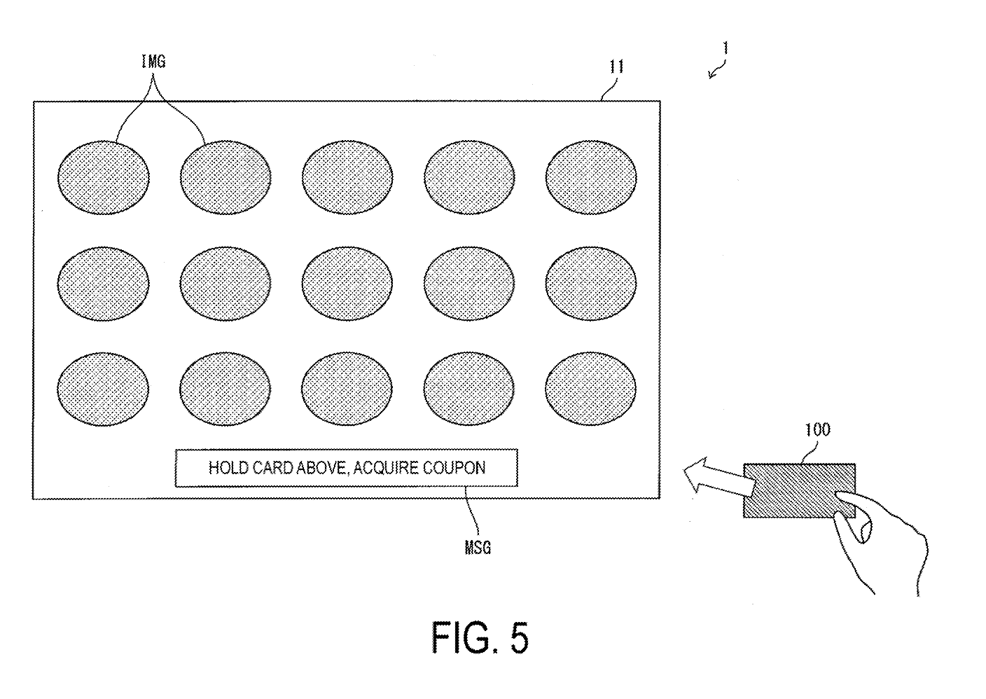

Note that the information processing device 20 may cause the display unit 113 to display a guide (e.g., an image IMG in FIG. 5 to be described later) indicating a position of the NFC antenna 114 on the display unit 113. According to the guide, it is possible to visually report to a user as to which position on the NFC display 11, the user is required to hold the NFC terminal 100 above in order to perform communication with the NFC antenna 114. In this way, according to the information processing system 1, a user is allowed to perform intuitive operations.

### Information Processing Device 20

The information processing device 20 is a device cooperative with the display device 10 and communicable with the NFC terminal 100. As illustrated in FIG. 1, the information processing device 20 includes the control unit 21 and a storage 22.

The control unit 21 integrally controls each unit of the display device 10 and the information processing device 20; and performs control of the display unit 113, control of the touch panel controller 12, control of the NFC controller 13, activation or control of a software (application) stored in the storage 22, and the like in response to a user's operation. The control unit 21, the NFC display 11 (e.g. the display unit 113), the touch panel controller 12, and the NFC controller 13 are communicably connected.

For example, the control unit 21 performs (i) drive control of the NFC unit 112 according to the above-described software, (ii) acquisition of various types of information included in the NFC terminal 100 (e.g., access to terminal information including personal data of each user) by communication with the NFC terminal 100, (iii) transmission of various types of information to the NFC terminal 100 by the communication, (iv) authentication (personal authentication) of a user possessing the NFC terminal 100, and the like. Further, the control unit 21 performs settlement processing and the like depending on a type of the above-described software.

The storage 22 stores various types of data used by the display device 10 or the information processing device 20. In the present embodiment, the storage 22 stores, as the above-described software, a software for use in playing a game to be described later, which determines whether or not a coupon usable at a prescribed shop is to be issued, for example. Further, the storage 22 stores, (i) the terminal information, (ii) antenna position information, (iii) various types of image information, (iv) prescribed coupon information (prescribed information) indicating a prescribed coupon, and (v) setting information set in advance in association with at least one of NFC antennas 114 indicated by antenna position information, for example.

Here, the terminal information is an NFC terminal ID for identifying the NFC terminal 100, terminal data being unique information held by the NFC terminal 100, and the like. In addition, the terminal information may include a user ID for identifying a user using the NFC terminal 100.

Note that, in the present embodiment, description is made in which the NFC terminal ID and/or the user ID is simply referred to as identification information. The identification information may be used for log-in authentication at the time of activation of various types of software, for example. An example of the above-described terminal data includes coupon information indicating various coupons acquired by a user.

The antenna position information is information indicating a correspondence relation between the antenna ID of the NFC antenna 114 and the position of the NFC antenna 114 having the antenna ID. The position information of the NFC antenna 114 (information indicating a position of each NFC antenna 114) may be XY plane coordinates at an upper left vertex and a lower right vertex of the NFC antenna 114 in an XY plane coordinate system defined on the NFC unit 112 by assuming that an upper left vertex of the NFC unit 112 is an origin, in a case where the NFC antenna 114 has a rectangular shape, for example. Alternatively, the position information may be XY plane coordinates at a center point of the NFC antenna 114 in the above-described XY plane coordinate system. However, the position information of the NFC antenna 114 is not limited to these examples.

The image information is information indicating a content depending on information stored in the NFC terminal 100 held above the NFC display 11, or a content depending on a held position of the NFC terminal 100. Note that, in a case where voice notification is available, voice information indicating the content may be stored in the storage 22.

In the present embodiment, the prescribed coupon information is information indicating a coupon usable at a prescribed shop, which is issued in a case where it is determined in a game to be described later that issuance of the coupon is possible. Further, the prescribed coupon information is a coupon (see FIG. 5 and the like) that is acquired by a user in the game to be described later. In the following, a coupon to be acquired by a user in the game is also referred to as a coupon A.

In the present embodiment, the setting information is information (information indicating a “hit”) indicating that a user is allowed to acquire the coupon A. Note that the NFC antenna 114 to be associated with the setting information may be changed each time the above-described software is activated, or after a prescribed period has elapsed, for example. Information (information indicating an “out”) indicating that a user is unable to acquire the coupon A may be associated with the NFC antenna 114 other than the NFC antenna 114 with which the above-described information indicating a hit is associated.

Note that various types of information stored in the storage 22 may be held by an external device (e.g., an in-house server, a cloud, or a personal PC) other than the display device 10 and the information processing device 20, and communicable with the information processing device 20.

Next, a specific configuration of the control unit 21 is described. The control unit 21 includes a terminal information acquisition circuit 211 (identification information acquisition circuit), a terminal position identification unit 212, an authentication circuit 213, a position determination circuit 214, an information presence/absence determination circuit 215, a processing permission circuit 216, and a display control unit 217.

The terminal information acquisition circuit 211 acquires the terminal information of the NFC terminal 100 from the NFC terminal 100 via the NFC unit 112.

The terminal position identification unit 212 identifies a position of the NFC terminal 100 held above the NFC display 11 on the display unit 113 (in other words, a position on the NFC display 11). Specifically, in a case where the NFC terminal 100 is held above the NFC display 11, the terminal position identification unit 212 identifies the NFC antenna 114 where the NFC terminal 100 is held above among a plurality of NFC antennas 114 disposed on the display unit 113.

For example, the terminal position identification unit 212 selects one of a plurality of NFC antennas 114 by controlling the NFC controller 13. Further, the terminal position identification unit 212 checks whether or not certain information is acquired (e.g., the terminal information acquisition circuit 211 acquires the terminal information) via the selected one NFC antenna 114 within a prescribed time. The terminal position identification unit 212 determines that a terminal capable of performing NFC, such as the NFC terminal 100, is held above, in a case where certain information is acquired. In this case, the terminal position identification unit 212 acquires the antenna ID indicating the NFC antenna 114 from the NFC antenna 114. Thus, the terminal position identification unit 212 is able to identify the NFC antenna 114, and thus, the terminal position identification unit 212 is able to identify a position on the display unit 113 where the NFC terminal 100 is held above. Specifically, the terminal position identification unit 212 performs the above-described identification by collating the antenna ID of the acquired NFC antenna 114 with the antenna position information stored in the storage 22. On the other hand, in a case where the terminal position identification unit 212 fails to acquire any information within a prescribed time, the terminal position identification unit 212 selects another NFC antenna 114. Further, similar to the above, the terminal position identification unit 212 checks whether or not certain information is acquired. The terminal position identification unit 212 identifies a position of the NFC antenna 114 where the NFC terminal 100 is held above by repeating this processing.

The authentication circuit 213 determines whether or not identification information acquired by the terminal information acquisition circuit 211 satisfies a prescribed condition. Specifically, the authentication circuit 213 performs authentication of the NFC terminal 100 by using the identification information acquired by the terminal information acquisition circuit 211, as determination processing as to whether or not the prescribed condition is satisfied. More specifically, the authentication circuit 213 collates the acquired identification information with the identification information stored in the storage 22. The authentication circuit 213 determines that authentication has succeeded in a case where the two pieces of identification information match with each other, and determines that authentication has failed in a case where the two pieces of identification information do not match with each other.

The position determination circuit 214 determines whether or not the terminal position being a position where the NFC terminal 100 comes in proximity to or comes into contact with the display unit 113 (specifically, a surface of the NFC display 11) corresponds to at least one prescribed position determined in advance.

In the present embodiment, the prescribed position indicates a position of at least one NFC antenna 114, for which setting information being information indicating a hit is set in advance, among a plurality of NFC antennas 114. Specifically, in the present embodiment, at least one of positions of a plurality of NFC antennas 114, and the above-described at least one prescribed position are associated with each other. The position determination circuit 214 determines whether or not the NFC antenna 114 identified by the terminal position identification unit 212 is the NFC antenna 114 for which the above-described setting information is set in advance by referring to the antenna position information stored in the storage 22.

The information presence/absence determination circuit 215 determines whether or not the coupon A (prescribed coupon information) is stored in the NFC terminal 100. Specifically, the information presence/absence determination circuit 215 determines whether or not the coupon A stored in the storage 22 is included in the coupon information stored in the NFC terminal 100, which is acquired via the NFC antenna 114.

The processing permission circuit 216 permits prescribed processing, in a case where the terminal information acquired by the terminal information acquisition circuit 211 satisfies a prescribed condition (specifically, authentication by the authentication circuit 213 succeeds), and the position determination circuit 214 determines that the above-described terminal position corresponds to the above-described prescribed position. Note that, in the following description, a complex condition obtained by combining two conditions, (1) a condition that the terminal information acquired by the terminal information acquisition circuit 211 satisfies a prescribed condition, and (2) a condition that the above-described terminal position is determined to correspond to the above-described prescribed position, may be referred to as a first condition. In other words, the processing permission circuit 216 permits prescribed processing, in a case where the above-described first condition is satisfied. In the present embodiment, the processing permission circuit 216 permits, as the prescribed processing, writing of the coupon A in the NFC terminal 100 held above the NFC display 11, in a case where the above-described first condition is satisfied.

Here, in a case where the prescribed processing is permitted, the information processing device 20 is in a state that the prescribed processing is executable. The processing permission circuit 216 permits execution of prescribed processing, in a case where the above-described first condition is satisfied, and the information presence/absence determination circuit 215 indicates a prescribed determination result. Specifically, only after a case where this execution is permitted, the processing permission circuit 216 executes prescribed processing. In the present embodiment, the processing permission circuit 216 determines whether or not execution of prescribed processing is permitted (specifically, whether or not permission based on the above-described first condition is validated, and prescribed processing is actually executed), based on a result of determination processing by the information presence/absence determination circuit 215, in addition to a result of authentication processing by the authentication circuit 213 and a result of determination processing by the position determination circuit 214.

More specifically, in the present embodiment, in a case where the above-described first condition is satisfied and the information presence/absence determination circuit 215 determines that the coupon A is not stored in the NFC terminal 100, the processing permission circuit 216 validates permission of writing the coupon A in the NFC terminal 100. Specifically, in a case where the above-described first condition is satisfied and the information presence/absence determination circuit 215 performs the above-described determination, the processing permission circuit 216 finally permits execution of the above-described writing. Further, the processing permission circuit 216 writes the coupon A in the NFC terminal 100 via the NFC antenna 114 by controlling the NFC controller 13.

In this case, although authentication of the NFC terminal 100 succeeds and a “hit” is determined in the above-described game, the coupon A associated with a “hit” is not stored in the NFC terminal 100. Therefore, the user using the NFC terminal 100 is able to acquire the coupon A associated with a “hit” by finally permitting execution of writing of the coupon A.

On the other hand, even in a case where the above-described first condition is satisfied, in a case where the information presence/absence determination circuit 215 determines that the coupon A is stored in the NFC terminal 100, the processing permission circuit 216 determines not to permit writing of the coupon A in the NFC terminal 100.

In this case, although authentication of the NFC terminal 100 succeeds and a “hit” is determined in the above-described game, the coupon A associated with a “hit” is already stored in the NFC terminal 100. Therefore, the processing permission circuit 216 does not write the coupon A in the NFC terminal 100 by determining not to permit writing of the coupon A. Therefore, it is possible to prevent a user using the NFC terminal 100 from acquiring the coupon A twice in a state that the coupon A is not used. Thus, it is possible to restrict acquisition of the coupon A, and promote use of the coupon A.

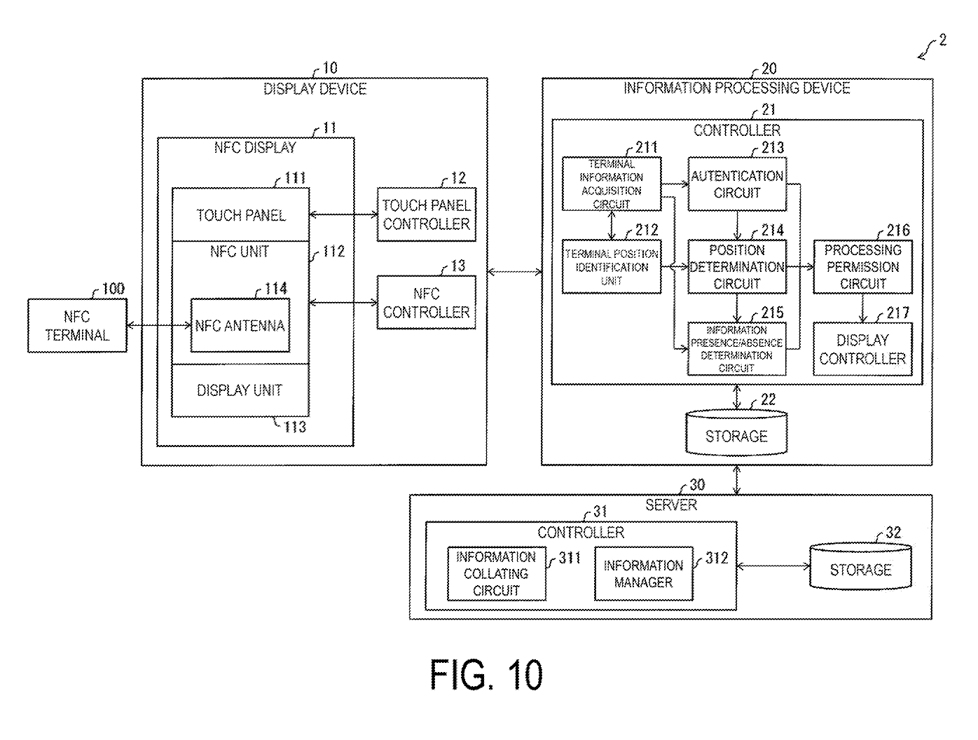

Note that, in a second embodiment, a processing permission circuit 216 causes a server 30 (see FIG. 10) to execute the processing, in a case where execution of the above-described processing is determined to be finally permitted. Specifically, in the second embodiment, the server 30 executes the processing.

Further, the processing permission circuit 216 instructs the display control unit 217 to display an image according to (i) an authentication result of the NFC terminal 100 by the authentication circuit 213, (ii) a determination result by the position determination circuit 214, and (iii) a determination result by the information presence/absence determination circuit 215.

The display control unit 217 controls the display unit 113. Specifically, the display control unit 217 acquires, from the storage 22, the image information indicating a content according to the above-described processing results (i) to (iii), and displays an image indicated by the image information via the display unit 113. Further, the display control unit 217 causes the display unit 113 to display an image for a progress of a game to be described later.

Note that, in a case where the information processing system 1 includes a loudspeaker (not illustrated), the control unit 21 may output voice or a notification sound indicating the above-described content via the loudspeaker. Presentation of the above-described content to a user does not have to be performed only by the display unit 113, and may be performed by both the display unit 113 and the loudspeaker or by only the loudspeaker.

### Use Example of Information Processing System 1

In the following, an overview of a use example of the information processing system 1 is described by exemplifying a case that the NFC terminal 100 is a membership card issued by a commercial facility (e.g., shopping mall). In this case, the display device 10 may be used as a digital signage (or an electronic billboard) in the commercial facility.

Generally, it is conceived that a frequency at which a digital signage of a commercial facility is used (e.g., advertisement information is viewed) by customers in the commercial facility is not so high. In view of this, in the present embodiment, in a case where the display device 10 is not used by customers for a certain period of time, a display screen of the display device 10 is switched to display a game screen to be described below.

As an example, the game screen is a screen configured to provide a user with a game by which the user acquires a coupon (electronic coupon) usable at a prescribed shop in a commercial facility. Displaying such a game screen on the display device 10 attracts attention of the customers to the display device 10. In this way, letting the customers play a game on the display device 10 allows to increase a frequency of use of the display device 10 by the customers.

However, it is to be noted that a type of the NFC terminal 100 is not limited to a membership card of a commercial facility, as described above. As an example, a type of the NFC terminal 100 may be an employee card of a company. Specifically, the NFC terminal 100 is only required to include information for use in performing prescribed authentication processing in the information processing device 20.

FIG. 4 is a diagram illustrating an arrangement example of the NFC antennas 114 on the NFC display 11. As illustrated in FIG. 4, three NFC antennas 114 in the vertical direction, and five NFC antennas 114 in the horizontal direction (fifteen NFC antennas 114 in total) are uniformly disposed on the NFC display 11. In the following, description is made by exemplifying a case that the above-described game screen is provided in the arrangement example of NFC antennas 114.

FIG. 5 is a diagram illustrating an example of the game screen to be display on the NFC display 11. More specifically, FIG. 5 illustrates a state before a user (customer) holds the NFC terminal 100 above the NFC display 11. Specifically, FIG. 5 illustrates an initial state of the game screen.

As illustrated in FIG. 5, each image IMG is displayed, in the game screen, at a position associated with each of the NFC antennas 114 in FIG. 4. As an example, each image IMG may be an image in imitation of a commodity (e.g., a doughnut) being a service target by a coupon. In this case, the coupon is a coupon usable at a doughnut shop, for example. A user is allowed to receive a service such as a discount of a commodity or free of charge by using this coupon.

More specifically, each of images IMG is displayed at a position where the image IMG overlaps an associated NFC antenna 114. Specifically, the image IMG serves as a guide indicating a position communicable with the NFC antenna 114. A user holds the NFC terminal 100 above the image IMG, and thus is allowed to perform communication with the NFC antenna 114 associated with the image IMG.

Therefore, in a case where a user holds the NFC terminal 100 above the image IMG, the information processing device 20 is able to acquire the terminal information of the NFC terminal 100 via the NFC antenna 114. Here, it is assumed that the terminal information includes (i) an ID number (hereinafter, also referred to as a membership ID) of a membership card as identification information, and (ii) the coupon information. Here, the membership ID is a unique identification number allocated to the membership card in advance in order to identify an owner of the membership card (NFC terminal 100).

Therefore, the information processing device 20 is able to acquire the membership ID and the coupon information via the NFC antenna 114. Thus, the information processing device 20 is able to collate the membership ID, and check whether or not the coupon A is included in the coupon information.

In addition to the above, the information processing device 20 further acquires the antenna ID of the NFC antenna 114 that has performed communication in acquisition of the membership ID and the coupon information. Therefore, as described above, the information processing device 20 is also able to identify the NFC antenna 114 with which the NFC terminal 100 performs communication.

Note that, in the game screen, a message MSG (operation guide), for example indicating a method for playing a game, may be further displayed in order to improve user's operability. As an example, in FIG. 5, characters “hold a card above and get a coupon” are displayed in a lower part of the game screen, as the message MSG. However, a content of various types of images (e.g., an image IMG and a message MSG) to be displayed on the NFC display 11 is not limited to the above-described example.

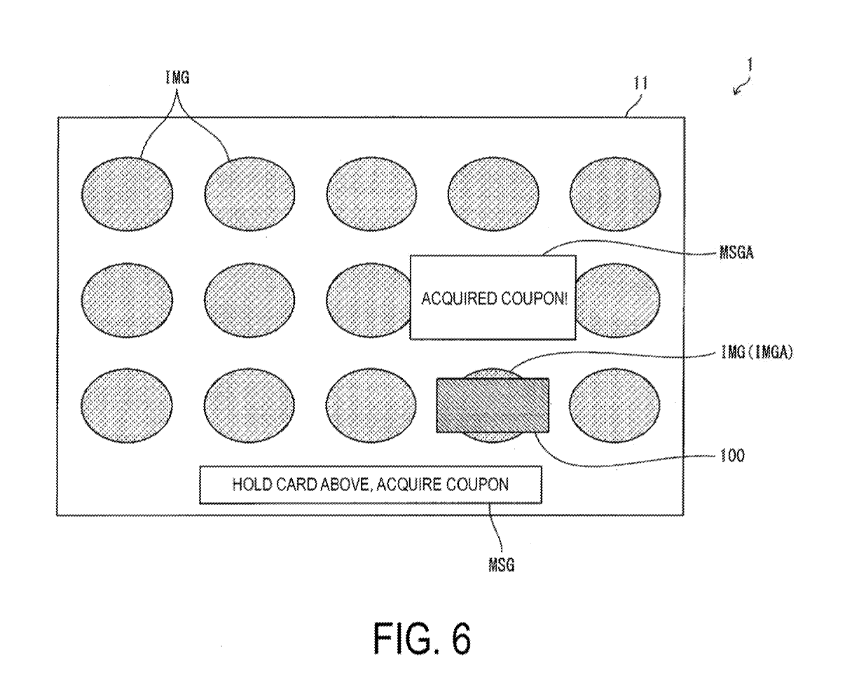

FIG. 6 is a diagram illustrating an example of the above-described game screen, and is a diagram illustrating a case that a user has held the NFC terminal 100 above and acquired the coupon (coupon A). Here, to distinguish a plurality of NFC antennas 114, the NFC antenna 114 for which a “hit” is set is also referred to as an NFC antenna 114A (also see FIG. 4). The image IMG associated with the NFC antenna 114A is also referred to as an image IMGA.

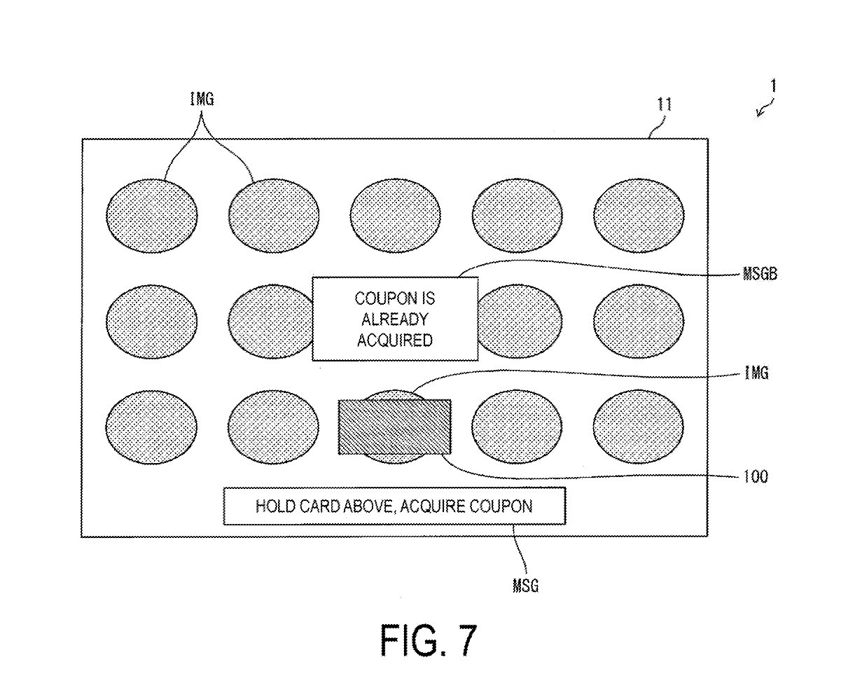

As illustrated in FIG. 6, in a case where a user holds the NFC terminal 100 above the NFC antenna 114A, the user is allowed to acquire the coupon (coupon A). More specifically, in a case where the NFC terminal 100 is held above the NFC antenna 114A, the information processing device 20 writes the coupon A in the NFC terminal 100. However, at a point of time before a state in FIG. 6, it is assumed that the coupon A is not included in the coupon information (also see FIG. 7 to be described later).

Note that, in a case where a user has acquired the coupon, a message MSGA indicating this acquisition may further be displayed. As an example, in FIG. 6, characters “coupon has been acquired” are displayed in an upper part of an image IMGA, as the message MSGA.

However, as described above, a method for reporting that a user has acquired a coupon is not limited only to the message MSGA. For example, in a case where a user has acquired a coupon, the information processing device 20 may cause a loudspeaker (not illustrated) to operate to report to the user by means of voice. A method for reporting to a user may be arbitrary selected by a designer of the information processing system 1 depending on a specification of the information processing system 1. This point is also similar regarding various reports to be described in the following.

FIG. 7 is a diagram illustrating an example of the above-described game screen, and is a diagram illustrating a state that a user holds the NFC terminal 100 above again following the state in FIG. 6. As illustrated in FIG. 7, in the information processing system 1, in a case where the coupon A is included in the coupon information, re-acquisition of the coupon A is restricted.

Specifically, in a case where the coupon A is determined to be included in the coupon information, the information processing device 20 does not write the coupon A in the NFC terminal 100 in any case where the NFC terminal 100 is held above any of the NFC antennas 114.

Note that, in a case where re-acquisition of the coupon A is restricted, a message MSGB indicating this restriction may further be displayed. As an example, in FIG. 7, characters “a coupon is already acquired” are displayed in an upper part of the image IMG where the NFC terminal 100 is held above, as the message MSGB.

A flow of operations for using the coupon A by a user (customer) uses is as described in the following (1) to (3), for example.

(1): First of all, a user holds the NFC terminal 100 above NFC equipment installed at a shop (e.g., a doughnut shop). Subsequently, the NFC equipment reads coupon information from the NFC terminal 100, and confirms that the coupon A is included in the coupon information.

(2): Subsequently, the NFC equipment reports, to a shop staff, that the user possesses the coupon A. Thus, a shop staff is able to receive the above-described report and provide the user with a service in accordance with the coupon A. Note that a report that a user possesses the coupon A may be performed from the NFC equipment to another equipment (e.g., automatic bending machine). In this case, the another equipment may receive the above-described report, and provide a user with a service in accordance with the coupon A.

(3): Subsequently, after the service in accordance with the coupon is provided to the user, information (use history information) indicating that the coupon A is used (consumed) is written in the NFC equipment by a staff or another equipment. The NFC equipment performs writing in the coupon information of the NFC terminal 100, based on the use history information. Specifically, the NFC equipment deletes the coupon A from the coupon information.

As described above, in a case where a user uses the coupon A, the coupon A is not included any more in the coupon information of the NFC terminal 100. Therefore, the user is allowed to acquire the coupon A again by playing the above-described game.

Note that, in the above description, one image IMG is associated with one NFC antenna 114 in the information processing system 1. However, in the information processing system 1, one image IMG may be associated with a plurality of NFC antennas 114.

For example, one image IMG may be displayed to overlap two NFC antennas 114. In this way, in the information processing system 1, one image IMG may be associated with one or more NFC antennas 114.

However, in the case where one image IMG is associated with a plurality of NFC antennas 114, all of such NFC antennas 114 are required to be equally set to either a “hit” or an “out”.

As an example, a case that one image IMG is associated with two NFC antennas 114 is assumed. In this case, the two NFC antennas 114 are required to be set to either a “hit” or an “out”.

In other words, it is to be noted that such setting is not permitted that one of the two NFC antennas 114 is set to a “hit” and the other is set to an “out”. This is because, with such setting, in a case where a user holds the NFC terminal 100 above the image IMG, it is not possible for the information processing device 20 to uniquely identify the determination result of a “hit” or an “out”.

### Overview of Processing of Information Processing Device 20

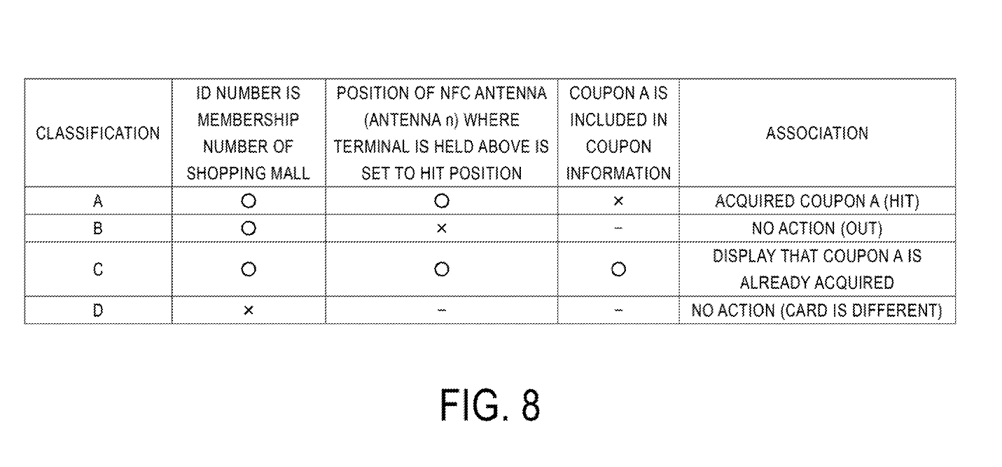

Next, an overview of processing of the information processing device 20 is described with reference to FIG. 8. FIG. 8 is a table illustrating classifications A to D of processing (associations) of the information processing device 20 in the above-described game. In the description hereinafter, the NFC terminal 100 is not limited to the above-described membership card, but also includes a case that the NFC terminal 100 is a general NFC card.

Note that, in FIG. 8, a symbol “o” is a logic symbol indicating “applied (YES)”. A symbol “x” is a logic symbol indicating “not applied (NO)”. A symbol “-” (hyphen) is a logic symbol indicating “either ∘ (YES) or x (NO)”, and is also referred to as a don't care.

For convenience of description, respective conditions illustrated in FIG. 8 are referred to as condition 1, condition 2, and condition 3 as follows. Specifically, respective conditions are referred to as:

(condition 1): a condition that “the ID number of the NFC terminal 100 is a membership number of a shopping mall (commercial facility)”;

(condition 2): a condition that “a position of the NFC antenna (also referred to as an antenna n) where a user holds the NFC terminal 100 above is set to a hit position”; and

(condition 3): a condition that “the coupon A is included in the coupon information”.

Classification A indicates an operation in a case of “condition 1: ∘”, “condition 2: ∘”, and “condition 3: x”. As an example, the above-described example in FIG. 6 is included in this classification A. In a case of classification A, the information processing device 20 allows a user to acquire the coupon A. Specifically, the information processing device 20 writes the coupon A in the coupon information of the NFC terminal 100.

Classification B indicates an operation in a case of “condition 1: ∘”, “condition 2: x”, and “condition 3: -”. In a case of classification B, the NFC terminal 100 does not perform communication with the NFC antenna 114 at a hit position, and thus the information processing device 20 determines to be an “out”. In this case, the information processing device 20 does not have to perform a specific operation. However, the information processing device 20 may report the “out” to the user.

Classification C indicates an operation in a case of “condition 1: ∘”, “condition 2: ∘”, and “condition 3: ∘”. In a case of classification C, the coupon A is already included in the coupon information, and thus, even in a case where the NFC terminal 100 performs communication with the NFC antenna at a hit position, the information processing device 20 reports to the user that the coupon A is already acquired. As an example, the above-described example in FIG. 7 is included in this classification C.

Classification D indicates an operation in a case of “condition 1: x”, “condition 2: -”, and “condition 3: -”. In a case of classification D, the ID number as the identification information stored in the held NFC terminal 100 does not correspond to the membership number of the shopping mall (commercial facility), the information processing device 20 determines that the NFC terminal 100 is not a membership card (different card is used). Also in this case, the information processing device 20 does not have to perform a specific operation. However, the information processing device 20 may report to the user that different card is used.

### Processing of Information Processing Device 20 in Present Embodiment

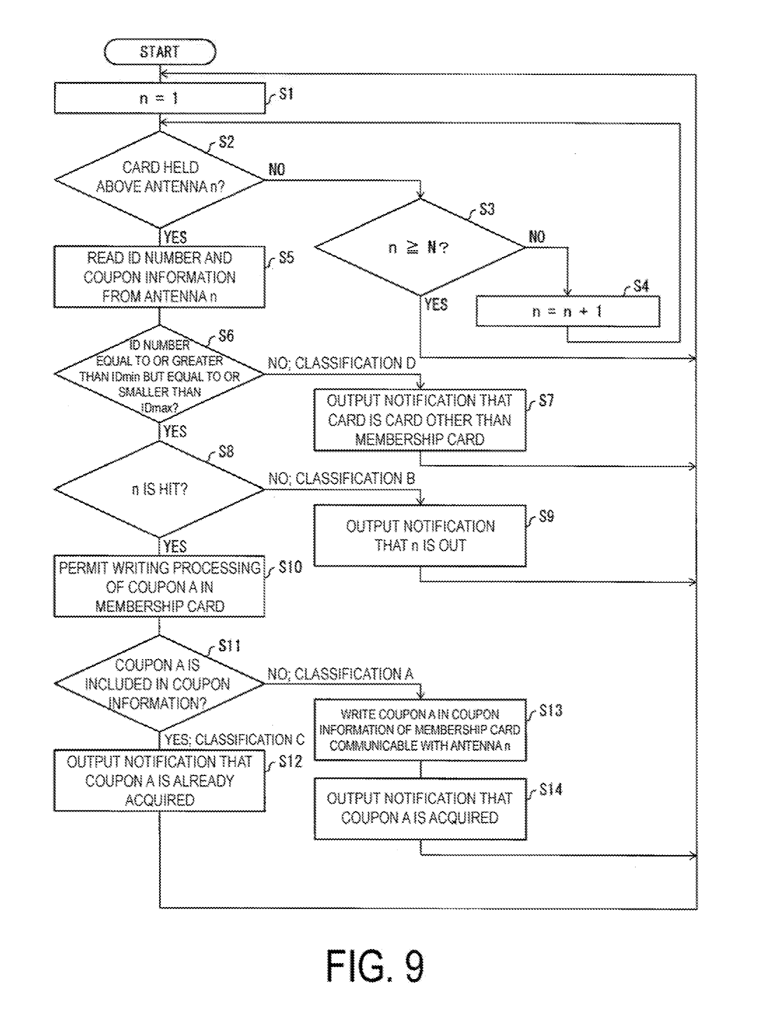

Next, an example of processing (control method) of the information processing device 20 is described more specifically with reference to FIG. 9. FIG. 9 is a flowchart illustrating an example of processing of the information processing device 20. Note that, in FIG. 9, n is a number set in association with each of the NFC antennas 114. A number n may be a number associated with the antenna ID, or may be the antenna ID itself N denotes the number of NFC antennas 114 provided in the display unit 113. As an example, in the above-described configuration of FIG. 4, N=15.

First of all, the control unit 21 of the information processing device 20 determines whether or not the NFC terminal 100 (card in FIG. 9) is held above the NFC display 11 (specifically, whether or not the NFC terminal 100 comes in proximity to or comes into contact with a surface of the NFC display 11). Specifically, the terminal position identification unit 212 sets the above-described number to be n=1 (S1). Further, the terminal position identification unit 212 determines whether or not the NFC terminal 100 is held above the NFC antenna 114 (antenna n) of the number n (S2).

Specifically, the terminal position identification unit 212 determines whether or not the terminal information acquisition circuit 211 acquires certain information via the NFC unit 112 within a prescribed period of time. In a case where the terminal position identification unit 212 does not acquire any information within the prescribed period of time, the terminal position identification unit 212 determines that the NFC terminal 100 is not held above (NO in S2), and determines whether or not the number n exceeds the number of antennas N (S3). In a case where n does not exceed N (NO in S3), the terminal position identification unit 212 increments the number n by 1 (S4), and performs the processing of S2 again. The terminal position identification unit 212 repeats this processing until a determination result becomes YES in S2 or YES in S3. Specifically, the terminal position identification unit 212 selects one NFC antenna 114 from among a plurality of NFC antennas 114, and checks whether or not the NFC terminal 100 is held above the NFC antenna 114. In a case where a determination result becomes YES in S3, it is determined that the NFC terminal 100 is not held above any of the NFC antennas 114, and the processing is returned to the processing of S1.

On the other hand, in a case where the terminal position identification unit 212 acquires certain information within the prescribed period of time, it is determined that the NFC terminal 100 is held above the NFC display 11 (YES in S2). In this case, the terminal position identification unit 212 notifies the terminal information acquisition circuit 211 of the determination result. The terminal information acquisition circuit 211 acquires, from the NFC terminal 100 being held above the NFC antenna 114 via the NFC antenna 114, the terminal information stored in the NFC terminal 100 (in FIG. 9, the ID number as identification information stored in the NFC terminal 100), and the coupon information (S5; identification information acquisition step). Further, the terminal information acquisition circuit 211 transmits the acquired ID number to the authentication circuit 213, and the acquired coupon information to the information presence/absence determination circuit 215.

In the processing of S5, the terminal information acquisition circuit 211 acquires, from the NFC antenna 114 through which the terminal information is acquired, the antenna ID indicating the NFC antenna 114, and transmits the antenna ID to the terminal position identification unit 212. The terminal position identification unit 212 refers to the antenna position information stored in the storage 22 to identify the antenna position information including an antenna ID that matches with the acquired antenna ID. The terminal position identification unit 212 transmits identified antenna position information to the position determination circuit 214.

Next, the authentication circuit 213 performs authentication of the NFC terminal 100. Specifically, the authentication circuit 213 determines whether or not the ID number indicated by the acquired terminal information is equal to or larger than IDmin and equal to or smaller than IDmax (S6). Here, IDmin is a lower limit value of the issued ID number, and IDmax is an upper limit value of the issued ID number. The authentication circuit 213 transmits, to the position determination circuit 214, a success notification indicating that authentication succeeds, in a case where the acquired ID number is equal to or larger than IDmin and equal to or smaller than IDmax (YES in S6). On the other hand, in a case where the ID number is a value smaller than IDmin and larger IDmax (NO in S6), the authentication circuit 213 transmits, to the processing permission circuit 216, a failure notification that authentication has failed.

Note that, in FIG. 9, the authentication of the NFC terminal 100 is performed as described above, but the authentication is not limited to this example. For example, the authentication circuit 213 may perform the above-described authentication by determining whether or not the acquired ID number matches with the ID number stored in the storage 22. In a case where the above-described ID number is constituted of numerals of several digits, the authentication circuit 213 may extract one or more numerals at a specific position (specific digit) from numerals constituting the ID number, and perform the above-described authentication by determining whether or not the extracted numeral is within a range between a predetermined lower limit value and a predetermined upper limit value. Note that, in a case where the NFC terminal 100 is a membership card, success of the above-described authentication means that the information processing device 20 determines that the NFC terminal 100 is the membership card to be processed.

In a case of YES in S6, the position determination circuit 214 that receives success notification determines whether or not the above-described terminal position is the above-described prescribed position. Specifically, the position determination circuit 214 determines whether or not information indicating a hit is associated, as the setting information, with the antenna position information indicating the position of the NFC antenna 114 of the number n, which is acquired from the terminal position identification unit 212, by referring to the storage 22, thereby determining whether or not the target position is a hit position (S8; position determination step).

In a case where the position determination circuit 214 determines that the above-described terminal position corresponds to the above-described prescribed position (the above-described position is a hit position) (YES in S8), the position determination circuit 214 transmits the determination result to the information presence/absence determination circuit 215 and to the processing permission circuit 216. Further, the processing permission circuit 216 temporarily permits, as prescribed processing, writing of the coupon A in the NFC terminal 100 due to the above-described first condition being satisfied (S10; processing permission step). On the other hand, in a case where the position determination circuit 214 determines that the above-described terminal position does not correspond to the above-described prescribed position (the above-described position is an out position (NO in S8), the position determination circuit 214 transmits the determination result to the processing permission circuit 216.

After the processing of S10, the information presence/absence determination circuit 215 that receives a determination result that the above-described terminal position corresponds to the above-described prescribed position determines whether or not the coupon A is included in the coupon information acquired from the terminal information acquisition circuit 211 (specifically, acquired from the NFC terminal 100 via the NFC antenna 114) (S11). In a case where the information presence/absence determination circuit 215 determines that the coupon A is included in the above-described coupon information (YES in S11), the information presence/absence determination circuit 215 transmits the determination result to the processing permission circuit 216. On the other hand, also in a case where the information presence/absence determination circuit 215 determines that the coupon A is not included in the above-described coupon information (NO in S11), the information presence/absence determination circuit 215 transmits the determination result to the processing permission circuit 216.

In a case where the processing permission circuit 216 receives the determination result that the coupon A is not included in the above-described coupon information, the processing permission circuit 216 determines that permission of writing the coupon A in the NFC terminal 100 that has acquired the ID number and the coupon information is valid (specifically, writing processing is actually executed). Further, in this case, the processing permission circuit 216 writes the coupon A in the NFC terminal 100 via the NFC antenna 114 by controlling the NFC controller 13 (S13). In other words, this case corresponds to classification A in the table illustrated in FIG. 8.

The processing permission circuit 216 instructs the display control unit 217 to notify that the coupon A is written in the NFC terminal 100 (specifically, a user has acquired the coupon A). In response to the instruction, the display control unit 217 performs the notification via the display unit 113 (S14).

On the other hand, in a case of NO in S6, the processing permission circuit 216 that receives a failure notification of the authentication determines that the NFC terminal 100 held above the NFC display 11 is not a prescribed NFC terminal 100 (here, a card other than a membership card), and does not permit writing of the coupon A in the NFC terminal 100. Further, in this case, the processing permission circuit 216 instructs the display control unit 217 to notify that the NFC terminal 100 is not the prescribed NFC terminal 100. In response to the instruction, the display control unit 217 performs the notification via the display unit 113 (S17). In other words, this case corresponds to classification D in the table illustrated in FIG. 8. Note that, in a case of NO in S6, as illustrated in FIG. 8, the control unit 21 may not perform specific processing (specifically, processing of S7).

In a case of NO in S8, the processing permission circuit 216 that receives a determination result indicating that the above-described terminal position is not the above-described prescribed position determines that the position of the NFC terminal 100 held above the NFC display 11 is an out position, and does not permit writing of the coupon A in the NFC terminal 100. Further, in this case, the processing permission circuit 216 instructs the display control unit 217 to notify that the position where the NFC terminal 100 is held above is an out position. In response to the instruction, the display control unit 217 performs the notification via the display unit 113 (S9). In other words, this case corresponds to classification B in the table illustrated in FIG. 8. Note that the processing permission circuit 216 may cause the display control unit 217 to notify that the NFC terminal 100 is not allowed to acquire the coupon A together with the above-described notification or in place of the above-described notification. In a case of NO in S8, as illustrated in FIG. 8, the control unit 21 may not perform specific processing (processing of S9).

In a case of YES in S11, the processing permission circuit 216 that receives a determination result indicating that the coupon A is included in the above-described coupon information does not permit writing of the coupon A in the NFC terminal 100 held above the NFC display 11. At this occasion, the processing permission circuit 216 invalidates permission of writing the coupon A in the NFC terminal 100, which is activated in S10. Specifically, the processing permission circuit 216 determines that the above-described writing is not permitted, since the coupon A is included in the above-described coupon information although the above-described first condition is satisfied. Further, in other words, the processing permission circuit 216 does not execute writing of the coupon A in the NFC terminal 100 that is temporarily permitted, since the coupon A is acquired in S11 and is determined to be unused, although the above-described position of the NFC terminal 100 is determined to be a hit position in S8. Further, in this case, the processing permission circuit 216 instructs the display control unit 217 to notify that the NFC terminal 100 has already acquired the coupon A. In response to the instruction, the display control unit 217 performs the notification via the display unit 113 (S12). In other words, this case corresponds to classification C in the table illustrated in FIG. 8.

Note that, in a case where the NFC controller 13 is provided in each of the NFC antennas 114, the information processing device 20 is able to perform the processing of S5 without performing the processing of S1 to S4 (scan processing).

The control unit 21 may perform three processing, that is, (i) authentication by the authentication circuit 213 in S6, (ii) determination by the position determination circuit 214 in S8, and (iii) determination by the information presence/absence determination circuit 215 in S11. For example, the control unit 21 may perform the above-described processing in the order of (i), (iii), and (ii), or may perform the above-described processing (i) to (iii) in parallel.

In the former case, in a case where authentication succeeds by the authentication circuit 213, determination processing by the information presence/absence determination circuit 215 is performed. In a case where the information presence/absence determination circuit 215 determines that the coupon A is not included in the coupon information acquired from the NFC terminal 100, determination processing by the position determination circuit 214 is performed. In a case where the position determination circuit 214 determines that the above-described terminal position corresponds to the above-described prescribed position, the processing permission circuit 216 permits writing of the coupon A in the NFC terminal 100, and writes the coupon A. On the other hand, in a case where the coupon A is included in the coupon information acquired from the NFC terminal 100, a notification indicating that the coupon A has already acquired is provided. Specifically, regardless of a position of the NFC terminal 100 held above after the notification, a notification indicating that the coupon A has already acquired is provided.

In other words, in the former case, in a case where the coupon A is not included in the coupon information acquired by the information processing device 20, in classification B in the table illustrated in FIG. 8, as an operation of the information processing device 20, no operation is done, or a notification that the position of the NFC terminal 100 held above is an “out” position is provided. Specifically, in this case, an item “the coupon A is included in the coupon information” is replaced from “-” to “x” in classification B in the table illustrated in FIG. 8.

In the former case, in a case where the coupon A is included in the coupon information acquired by the information processing device 20 in classification C, a notification that the coupon A has already acquired is provided, as the operation of the information processing device 20, regardless of whether the position of the NFC terminal 100 held above is a “hit position” or an “out” position. Specifically, in this case, an item “the position of the NFC antenna (antenna n) where the NFC terminal 100 is held above is set to a hit position” is replaced from “∘” to “-” in classification C in the table illustrated in FIG. 8.

Note that, in the processing of FIG. 9, in a case of NO in S8, the processing may be proceeded to the processing S9, and a notification indicating that the position of the NFC terminal 100 is an out position may not be provided. For example, in the case of NO in S8, writing of the coupon A in the NFC terminal 100 may not be permitted, and the processing may be proceeded to the processing S11. Further, in a case where it is determined that the coupon A is included in the coupon information acquired from the NFC terminal 100 in S11, the processing may proceed to the processing S12, in place of performing the processing S9.

In other words, in this case, in a case where the position of the NFC terminal 100 held above is an out position and the coupon A is stored in the NFC terminal 100, a notification indicating that the coupon A has already acquired is provided, in place of providing the notification indicating that the position of the NFC terminal 100 is an out position. Further, in this case, only in a case where the position of the NFC terminal 100 held above is an out position, and the coupon A is not stored in the NFC terminal 100, the notification indicating that the position of the NFC terminal 100 is an out position is provided (processing S9). Therefore, also in this case, similar to the above, an item “the coupon A is included in the coupon information” is replaced from “-” to “x” in classification B in the table illustrated in FIG. 8, and an item “the position of the NFC antenna (antenna n) where the NFC terminal 100 is held above is set to a hit position” is replaced from “∘” to “-” in classification C.

### Primary Advantageous Effects of First Embodiment

As described above, the information processing device 20 is connected to the display device 10 in which a plurality of NFC antennas 114 (multi-antenna) are disposed on the display unit 113, in such a way that data transmission and/or reception can be performed. Further, the information processing device 20 permits prescribed processing, in a case where identification information of the NFC terminal 100 held above the NFC display 11 satisfies a prescribed condition, and the held position (terminal position) corresponds to the above-described prescribed position (specifically, a case that the above-described first condition is satisfied). In other words, the information processing device 20 is able to provide a state that prescribed processing is executable only by performing determination processing as to whether or not this prescribed condition is satisfied, and determination processing as to whether or not the position of the NFC terminal 100 corresponds to the above-described prescribed position. Therefore, it is possible to execute various types of processing (functions) by means of simple operations and processing.

Further, in the present embodiment, the prescribed processing indicates writing processing of the coupon A in the above-described NFC terminal 100. In a case where the above-described first condition is satisfied, and the coupon A is not stored in the above-described NFC terminal 100, the information processing device 20 executes the above-described writing processing. On the other hand, in a case where the coupon A is stored in the above-described NFC terminal 100, the information processing device 20 does not execute the above-described writing processing that is temporarily permitted. By performing such processing, in a case where the coupon A is included in the above-described NFC terminal 100 (specifically, the coupon A is not used, in other words, the coupon A has already acquired), it is possible to provide restriction that indicates not re-writing the coupon A. Specifically, it is possible to restrict a function of writing processing.

Further, as described above, in a case where the coupon A is deleted by the NFC equipment, writing of the coupon A in the NFC terminal 100 is re-executable. Specifically, it is possible to use the NFC terminal 100 again as an acquisition target of the coupon A by a specific operation that the coupon A is deleted. In other words, it is possible to release the above-described restriction by the above-described specific operation.

### Second Embodiment

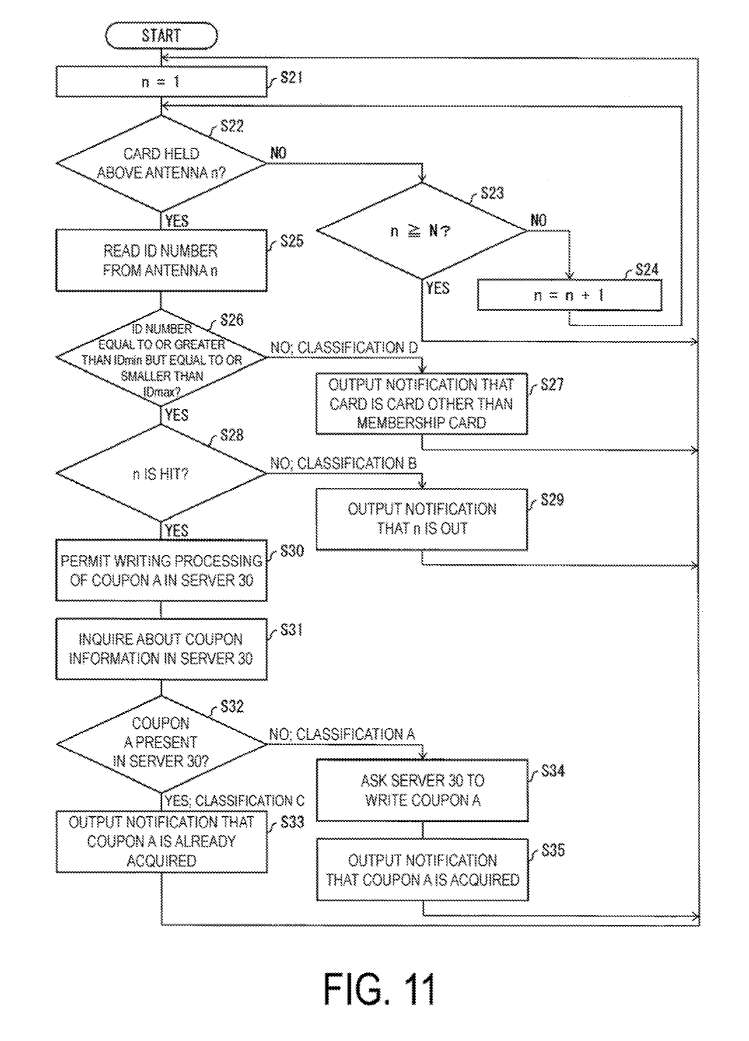

A second embodiment of the present disclosure is described as follows, based on FIG. 10 and FIG. 11. Note that, for convenience of explanation, components illustrated in respective embodiments are designated by the same reference numerals as those having the same function, and the descriptions of these components will be omitted.

FIG. 10 is a functional block diagram illustrating a configuration of main components of an information processing system 2 in the present embodiment. The information processing system 1 in the first embodiment includes the display device 10 and the information processing device 20. However, as illustrated in FIG. 10, the information processing system 2 in the second embodiment further includes a server 30 (management device).

### Information Processing System 2

The server 30 is a management device that manages terminal information (membership ID and coupon information) stored in an NFC terminal 100 being a processing target by the information processing device 20. Specifically, the server 30 manages the terminal information of the NFC terminal 100 for each NFC terminal 100, or for each user using the NFC terminal 100. The server 30 includes a storage 32 configured to store the terminal information in order to manage the terminal information of each NFC terminal 100. Specifically, in the present embodiment, coupon information is managed by the server 30, in place of the NFC terminal 100. The server 30 also manages a coupon A issued at a prescribed shop.

The server 30 includes a control unit 31 that integrally controls each unit of the server 30, particularly, functions of the server 30. Further, the control unit 31 includes an information collating circuit 311 and an information manager 312.

The information collating circuit 311 determines whether or not the coupon A is included in the coupon information possessed by the NFC terminal 100 held above the NFC display 11 (or a user using the NFC terminal 100), and managed in the storage 32.

The information manager 312 updates the coupon information by writing the coupon A in the coupon information associated with a membership ID of the NFC terminal 100, only in a case where a writing instruction from the information processing device 20 is received.

In a case where the coupon A is used at a shop or the like, the information manager 312 updates the coupon by deleting the coupon A written in the coupon information in association with the membership ID of the NFC terminal 100.

Specifically, in a case where a user holds the NFC terminal 100 above the NFC equipment installed at a shop, the NFC equipment acquires the membership ID stored in the NFC terminal 100. Subsequently, the NFC equipment transmits, to the server 30, the acquired membership ID, and a collation instruction indicating an instruction to collate whether or not the coupon A is included in the coupon information stored in association with the membership ID.

In the server 30, in response to reception of the above-descried membership ID and the collation instruction, the information collating circuit 311 determines whether or not the coupon A is included (written) in the coupon information stored in association with the membership ID, and transmits a determination result to the NFC equipment.

In a case where the above-described determination result indicates that the coupon A is included in the above-described coupon information, the NFC equipment reports to a shop staff that the user possesses the coupon A. Thereafter, in a case where a service in accordance with the coupon A is provided to the user, the NFC equipment transmits, to the server 30, a completion notification indicating that the service is completed. In the server 30, in response to reception of the completion notification, the information manager 312 deletes the coupon A included in the coupon information stored in association with the membership ID of which the information collating circuit 311 performs collation. Thus, similar to the first embodiment, a user is allowed to acquire the coupon A again.

The information processing system 2 includes the server 30, and thus a configuration of the information processing device 20 is different from the configuration described in the first embodiment in the following points.

Specifically, an information presence/absence determination circuit 215 determines whether or not the coupon A is included in the coupon information stored in the storage 32 of the server 30 in association with the membership ID of the NFC terminal 100 held above the NFC display 11. In other words, the information presence/absence determination circuit 215 determines whether or not the coupon A is stored in the server 30 in association with the above-descried NFC terminal 100.

In a case where identification information (ID number) acquired by a terminal information acquisition circuit 211 satisfies a prescribed condition (specifically, authentication by an authentication circuit 213 succeeds), and a position determination circuit 214 determines that the above-described terminal position corresponds to the above-described prescribed position (specifically, a case that the above-described first condition is satisfied), a processing permission circuit 216 permits prescribed processing. In the present embodiment, in a case where the above-described first condition is satisfied, the processing permission circuit 216 permits, as the prescribed processing, management of the coupon A associated with the membership ID as the above-described identification information (specifically, the NFC terminal 100 held above the NFC display 11) by the server 30. Specifically, the processing permission circuit 216 permits writing of the coupon A in the coupon information stored in association with the above-described membership ID by the server 30.

In the present embodiment, in a case where the above-described first condition is satisfied, and the information presence/absence determination circuit 215 determines that the coupon A is not stored in the server 30 in association with the membership ID of the above-described NFC terminal 100, the processing permission circuit 216 validates permission of management of the coupon A associated with the above-descried membership ID by the server 30. In this case, the processing permission circuit 216 transmits, to the information manager 312 of the server 30, a writing instruction of instructing to write the coupon A in the coupon information associated with the above-described membership ID.

On the other hand, even in a case where the above-described first condition is satisfied, in a case where the information presence/absence determination circuit 215 determines that the coupon A is stored in the server 30 in association with the membership ID of the above-described NFC terminal 100, the processing permission circuit 216 determines that the above-described management is not permitted. Specifically, in this case, the processing permission circuit 216 is also able to invalidate the above-described permission of management that is given temporarily. In this case, the processing permission circuit 216 does not transmit the above-described writing instruction.

### Processing of Information Processing Device 20 in Present Embodiment

Next, an example of processing (control method) of the information processing device 20 in the present embodiment is described using FIG. 11. FIG. 11 is a flowchart illustrating an example of processing of the information processing device 20 in the present embodiment. Note that processing of S21 to S24, S26 to S29, S33, and S35 are similar to the processing of S1 to 4, S6 to S9, S12, and S14, respectively, description is omitted herein.

In S25, the terminal information acquisition circuit 211 acquires, from the NFC terminal 100 held above the NFC antenna 114 via the NFC antenna 114, identification information (ID number) as the terminal information stored in the NFC terminal 100 (identification information acquisition step). Further, the terminal information acquisition circuit 211 transmits the acquired ID number to the authentication circuit 213.

In the processing S25, the terminal information acquisition circuit 211 acquires, from the NFC antenna 114 that acquires the ID number, the antenna ID indicating the NFC antenna 114, and transmits the antenna ID to a terminal position identification unit 212. The terminal position identification unit 212 transmits identified antenna position information to the position determination circuit 214, as with the first embodiment.

Thereafter, in the processing S28, in a case where the position determination circuit 214 determines that the above-described terminal position corresponds to the above-described prescribed position (the position of the NFC terminal 100 held above the NFC display 11 is a hit position) (YES in S28), the position determination circuit 214 transmits the determination result to the information presence/absence determination circuit 215 and to the processing permission circuit 216. Further, in the present embodiment, in a case where the above-described terminal position is determined to correspond to the above-described prescribed position, the processing permission circuit 216 temporarily permits, as prescribed processing, management of the coupon A associated with the membership ID of the above-described NFC terminal 100 (writing of the coupon A in the coupon information stored in association with the above-described membership ID) by the server 30 (S30; processing permission step).

After the processing S30, the information presence/absence determination circuit 215 that receives the determination result that the above-described terminal position corresponds to the above-described prescribed position transmits, to the server 30, the membership ID (ID number acquired in the processing S25) and the collation instruction (S31).

In the server 30, in response to reception of the above-described membership ID and the collation instruction, the information collating circuit 311 determines whether or not the coupon A is included in the coupon information stored in association with the membership ID, and transmits a determination result to the information processing device 20. In the information processing device 20, the information presence/absence determination circuit 215 determines whether or not the coupon A is included in the above-described coupon information (specifically, whether or not there is the coupon A stored in association with the above-described membership ID in the server 30), based on the above-described determination result (S32).

In a case where the information presence/absence determination circuit 215 determines that the coupon A is included in the above-described coupon information (YES in S32), the information presence/absence determination circuit 215 transmits the determination result to the processing permission circuit 216. On the other hand, also in a case where the information presence/absence determination circuit 215 determines that the coupon A is not included in the above-described coupon information (NO in S32), the information presence/absence determination circuit 215 transmits the determination result to the processing permission circuit 216.

In a case where the processing permission circuit 216 receives the determination result that the coupon A is not included in the above-described coupon information, the processing permission circuit 216 determines that permission of management of the coupon A associated with the above-described membership ID by the server 30 is valid (specifically, the above-described writing is actually executed). In other words, the processing permission circuit 216 transmits the above-described writing instruction to the information manager 312 of the server 30 (S34). In this case, in response to reception of the above-described writing instruction, the information manager 312 updates the coupon information by writing the coupon A in the coupon information associated with the above-described membership ID received by the information collating circuit 311.

On the other hand, in a case where the processing permission circuit 216 receives the determination result that the coupon A is included in the above-described coupon information, the processing permission circuit 216 invalidates permission of writing the coupon A associated with the above-described membership ID in the server 30. Specifically, the processing permission circuit 216 determines not to permit the above-described management (above-described writing), since the coupon A is included in the above-described coupon information, although the above-described first condition is satisfied. In this case, the processing permission circuit 216 causes a display control unit 217 to notify that a user has already acquired the coupon A, without transmitting the above-described writing instruction to the information manager 312 of the server 30 (S33).

### Primary Advantageous Effects of Second Embodiment

The information processing system 2 includes the server 30, and is able to manage the membership ID of the NFC terminal 100 and the coupon information in the server 30.

Further, even in a case where the server 30 is provided, it is possible to produce a similar advantageous effect to the first embodiment.

Specifically, (i) the information processing device 20 is enabled to execute various types of processing (functions) by means of simple operations and processing.

Further, (ii) in a case where the above-described first condition is satisfied, and the coupon A is not stored in the server 30 in association with the NFC terminal 100 held above the NFC display 11, the information processing device 20 causes the server 30 to execute the above-described management (above-described writing). On the other hand, in a case where the above-described first condition is satisfied, but the coupon A is stored in the server 30 in association with the above-described NFC terminal 100, the information processing device 20 does not cause the server 30 to execute the above-described writing that is temporarily permitted. By performing such processing, in a case where the coupon A is managed in association with the above-described NFC terminal 100 (specifically, the coupon A is not used), it is possible to restrict the coupon A from being re-written in association with the NFC terminal 100. Specifically, it is possible to restrict a function of the above-described management (above-described writing).

Further, (iii) in a case where the above-described completion notification is received from the NFC equipment, the server 30 deletes the coupon A stored in association with the NFC terminal 100 used by a user who received a service. In this case, management of the coupon A associated with the NFC terminal 100 by the server 30 is re-executable. Specifically, a specific operation of deleting the coupon A restores the NFC terminal 100 as an acquisition target of the coupon A. In other words, it is possible to release the above-described restriction by the above-described specific operation.

### Third Embodiment

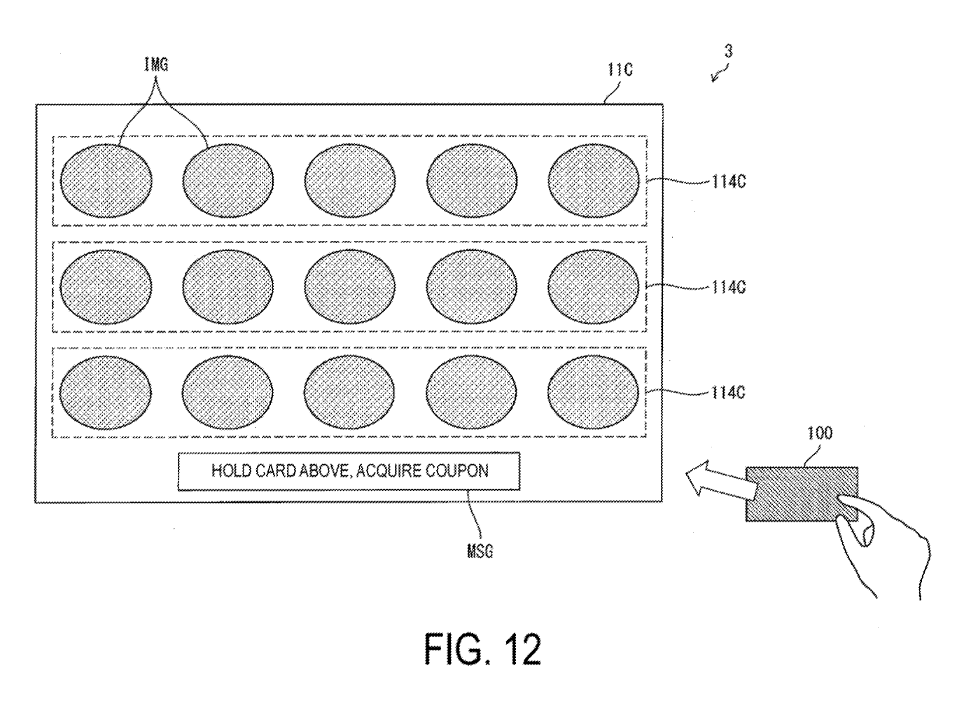

A third embodiment of the present disclosure is described as follows, based on FIG. 12 to FIG. 14. In the above-described respective embodiments, description is made by exemplifying a configuration in which a position on a surface of the NFC display 11, at which the NFC terminal 100 comes into contact with or in proximity to is identified (detected) by a communication result of the NFC antenna 114. However, in an information processing system according to one aspect of the present disclosure, a configuration in which the above-described position is detected by a touch panel 111 (touch sensor) may be employed.

In the present embodiment, as an example of the configuration, description is made by exemplifying an information processing system 3 to be described in the following. Note that a functional block diagram of the information processing system 3 is similar to the above-described information processing system 1, and thus illustration thereof is omitted.

The information processing system 3 includes a configuration in which the NFC antenna 114 is replaced by an NFC antenna 114C (antenna) in the above-described information processing system 1. Note that, in order to distinguish from the above-described NFC display 11, an NFC display in the present embodiment is referred to as an NFC display 11C.

Note that, in the present embodiment, description is made by exemplifying a case that a user causes the NFC terminal 100 to touch (come into contact with) the NFC display 11C. However, the same description is applied to a case that a user causes the NFC terminal 100 to come in proximity to the NFC display 11C. However, in terms of improving accuracy of position detection of the NFC terminal 100 on the touch panel 111, it is preferable to cause the NFC terminal 100 to touch the NFC display 11C.

FIG. 12 is a diagram illustrating an arrangement example of the NFC antennas 114C in the information processing system 3. Note that, in FIG. 12, for convenience of explanation, the NFC antennas 114C are illustrated by dotted lines in a game screen (initial screen) on which the above-described images IMG are displayed.

However, it is to be noted that, actually, the NFC antennas 114C are hardly visually recognized by a user viewing the game screen. This is because the NFC antennas 114C are transparent antennas, as with the NFC antennas 114.

As illustrated in FIG. 12, three NFC antennas 114C are equidistantly disposed in the vertical direction on the NFC display 11C. The NFC antennas 114C in the present embodiment are different from the above-described NFC antennas 114 in a point that the NFC antennas 114C have a length substantially equal to the length of the NFC display 11C in the horizontal direction.

As illustrated in FIG. 12, the images IMG are displayed in such a way that five (a plurality of) images IMG overlap one NFC antenna 114C on the NFC display 11C for each of the NFC antennas 114C.

As will be described in the following, on the NFC display 11C, at least a part of a position where the images IMG are displayed is set in such a way that a coupon is acquired (determined to be “hit”) in a case where a user causes the NFC terminal 100 to touch the NFC display 11C. Specifically, a position where the images IMG are displayed is a position where it is possible to acquire a coupon by the above-described touch, in a case where the coupon (coupon A) acquirable by playing a game is not stored in the NFC terminal 100. Hereinafter, the position is referred to a coupon acquisition position.

In other words, the coupon acquisition position is a touch position on a surface of the NFC display 11 where a user touches, and is a position where the coupon is acquirable in a case where information indicating a hit is set at the coupon acquisition position, and the above-described coupon is not stored in the NFC terminal 100. On the other hand, the coupon acquisition position is a position where the coupon is not acquirable, in a case where the above-described information is not set at the coupon acquisition position, or the above-described coupon is stored in the NFC terminal 100. Note that, each image IMG is an image indicating the coupon acquisition position, the image IMG may be referred to as a coupon acquisition position image.

Meanwhile, as described above, in the information processing system 1, one image IMG is associated with one or more NFC antennas 114.

On the other hand, as illustrated in FIG. 12, in the information processing system 3, one NFC antenna 114C is associated with a plurality of (five) images IMG. Therefore, by touching the NFC terminal 100 to any one of five images IMG associated with one NFC antenna 114C, the user can cause the NFC terminal 100 to communicate with the one NFC antenna 114C.

However, in the information processing system 3, similar to the information processing system 1, one image IMG may be associated with one NFC antenna 114C. In other words, in the information processing system 3, one NFC antenna 114C may be associated with one or more images IMG.

Further, as described above, in a case where a user causes the NFC terminal 100 to touch any of the images IMG, a touch panel controller 12 analyzes signal information supplied from the touch panel 111, and identifies a position on the touch panel 111 (NFC display 11C) where the NFC terminal 100 comes into contact.

The touch panel controller 12 transmits, to the information processing device 20 (more specifically, terminal position identification unit 212), position information indicating the touch position (specifically, touch acquisition position). Therefore, the information processing device 20 is possible to determine whether or not the touch position is a position where information indicating a hit is set.

Further, touching the NFC terminal 100 to any of the images IMG (in other words, a coupon acquisition position) causes communication between the NFC terminal 100 and the NFC antenna 114C. Therefore, as described above, the information processing device 20 is also able to acquire the terminal information from the NFC terminal 100. As will be described in the following, determination as to whether or not a coupon is acquired by a user is made by determination processing similar to the above-described first embodiment, except for a hit determination by collation of the coupon acquisition position.

### Overview of Processing of Information Processing Device 20 in Present Embodiment

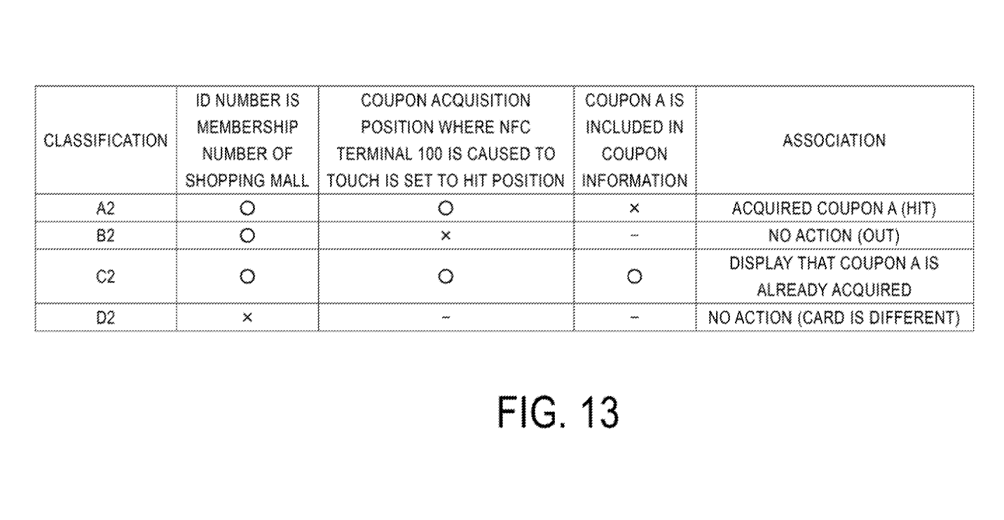

An overview of processing of the information processing device 20 in the present embodiment is described with reference to FIG. 13. FIG. 13 is similar to the above-described FIG. 8 except that above-described condition 2 is replaced by condition 2P described below. Therefore, description on a content similar to FIG. 8 is omitted.

(Condition 2P): a condition that “the coupon acquisition position touched by the NFC terminal 100 is set to a hit position”.

Note that, in order to distinguish from classifications A to D in FIG. 8, classifications in FIG. 13 are indicated as classifications A2 to D2. Contents of classifications A2 to D2 are specifically as follows.

Classification A2 is a classification similar to above-described classification A, and indicates an operation in a case of “condition 1: ∘”, “condition 2P: ∘”, and “condition 3: x”. In a case of classification As, the information processing device 20 allows a user to acquire the coupon A. Specifically, the information processing device 20 writes the coupon A in the coupon information of the NFC terminal 100.

Classification B2 is a classification similar to above-described classification B, and indicates an operation in a case of “condition 1: ∘”, “condition 2P: x”, and “condition 3: -”. In a case of classification B2, the touched coupon acquisition position does not correspond to a hit position, and thus, the information processing device 20 determines that the position is an out position.

Classification C2 is a classification similar to above-described classification C, and indicates an operation in a case of “condition 1: ∘”, “condition 2P: ∘”, and “condition 3: ∘”. In a case of classification C, the coupon A has already included in the coupon information, and thus, even in a case where the touched coupon acquisition position is a hit position, information that the coupon A has already been acquired is reported to a user.

Note that, as for classification D2, an operation is determined only from condition 1 as with above-described classification D, and thus, description thereof is omitted.

### Processing of Information Processing Device 20 in Present Embodiment

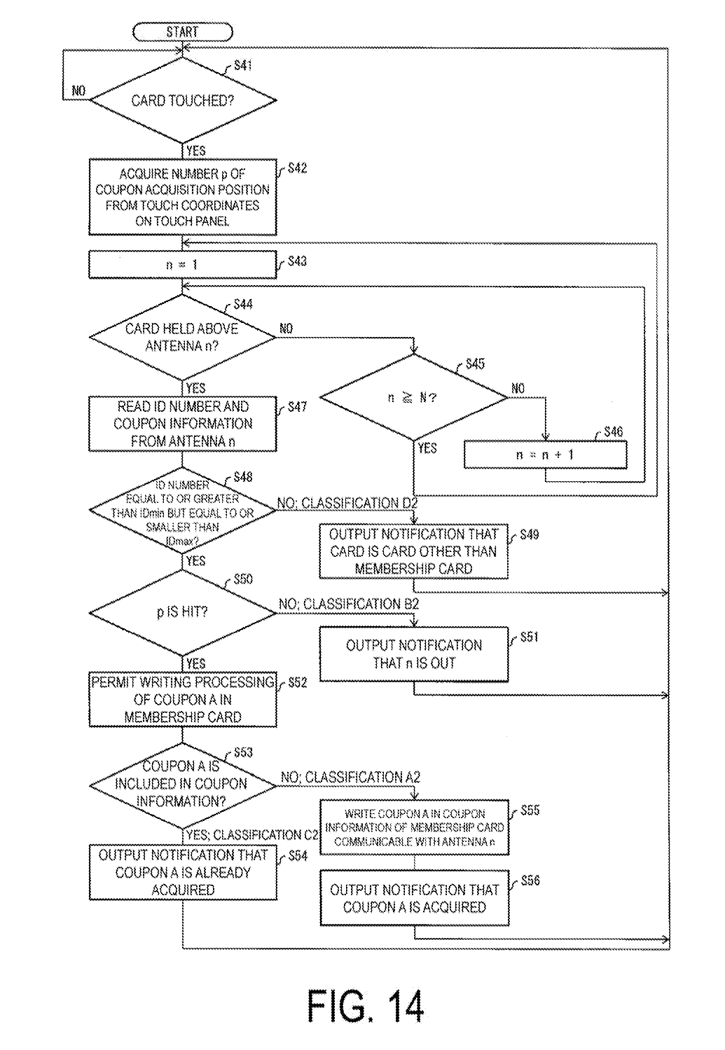

Next, an example of processing (control method) of the information processing device 20 in the present embodiment is described using FIG. 14. FIG. 14 is a flowchart illustrating an example of processing of the information processing device 20 in the present embodiment. Note that processing of S43 to S49, and S51 to S56 are similar to the processing of S1 to S7, and S9 to S14, respectively, description is omitted herein.

Note that, in the following description, a prescribed position indicates at least one touch acquisition position where setting information being information indicating a hit is set in advance, among a plurality of touch acquisition positions (touch positions (terminal positions) acquired by the touch panel 111). Specifically, in the present embodiment, at least one of a plurality of touch acquisition positions is associated with the above-described at least one prescribed position.

First of all, the terminal position identification unit 212 determines whether or not the NFC terminal 100 (in this example, a card) is touched to the NFC display 11 (S41). Specifically, the terminal position identification unit 212 determines whether or not the NFC terminal 100 is touched the NFC display 11 by analyzing signal information transmitted from the touch panel controller 12.

In a case where it is determined that the NFC terminal 100 is touched to the NFC display 11 (YES in S41), the terminal position identification unit 212 identifies a touch position (touch coordinates) of the NFC terminal 100 indicated by the above-described signal information. Further, the terminal position identification unit 212 acquires the identified touch position, specifically, a number p of the identified touch acquisition position by referring to the storage 22 (S42). In a case of NO in S41, the processing S41 is continued.

Note that a processing order of (1) processing of S41 and S42, and (2) processing of S43 to S47 may be reversed, or the processing may be performed in parallel.

Thereafter, in S50, the position determination circuit 214 determines whether or not information indicating a hit is associated, as setting information, with a touch acquisition position having the number p, which is acquired from the terminal position identification unit 212 by referring to the storage 22, thereby determining whether or not the touch acquisition position is a hit position (position determination step).

In a case where the position determination circuit 214 determines that the above-described terminal position corresponds to the above-described prescribed position (the above-described touch acquisition position is a hit position) (YES in S50), the processing is proceeded to the processing S52. In a case where the above-described terminal position is determined not to correspond to the above-described prescribed position (the above-described touch acquisition position is an out position) (NO in S50), the processing is proceeded to the processing S51. In other words, in the first embodiment, the position determination circuit 214 uses a position of the NFC antenna 114 indicated by the antenna position information as the above-described terminal position, whereas in the present embodiment, the position determination circuit 214 uses a touch acquisition position acquired on the touch panel 111 as the above-described terminal position.

Note that, in FIG. 14, a writing destination of the coupon A is the NFC terminal 100, the present embodiment, however, is not limited to this example. Similar to the second embodiment, the writing destination may be the server 30. Specifically, it is also possible to apply processing of the information processing device 20 in the present embodiment (particularly, processing of the position determination circuit 214 based on the touch acquisition position of the NFC terminal 100 acquired on the touch panel 111) to the information processing device 20 in the second embodiment.

### Primary Advantageous Effects of Third Embodiment

As described above, in the information processing system 3, a determination is made as to whether or not the terminal position acquired on the touch panel 111 corresponds to a prescribed position in the information processing device 20. In other words, also by using the touch panel 111 and the NFC antenna 114C in combination, it is possible to check (i) whether or not the above-described identification information satisfies a prescribed condition, and (ii) whether or not the terminal position corresponds to a prescribed position. Therefore, similar to the above-described first embodiment, it is possible to execute various types of processing by means of simple operations and processing.

It is possible to improve detection accuracy of the terminal position by detecting the terminal position by the touch panel 111 (touch sensor), as compared with a case that the terminal position is detected by the NFC antenna 114C. Specifically, according to the information processing system 3, it is possible to detect the terminal position with enhanced accuracy, and thus it is also possible to improve user's operability.

### Fourth Embodiment

Each control block (in particular, each component of the control unit 21 included in the information processing device 20) of the information processing systems 1 to 3 may be realized by a logic circuit (hardware) formed in an integrated circuit (IC chip) and the like, or by software by using Central Processing Unit (CPU).

In the latter configuration, each of the information processing systems 1 to 3 includes a CPU for executing instructions of a program which is software for implementing each function, a Read Only Memory (ROM) or a storage device (each of these is referred to as a “recording medium”) in which the program and various types of data are recorded in a computer-readable (or CPU-readable) manner, a Random Access Memory (RAM) in which the program is loaded, and the like. Then, the computer (or CPU) reads the program from the recording medium and executes the program to achieve the object of an aspect of the present disclosure. As the recording medium, a “non-transitory tangible medium”, such as a tape, a disk, a card, a semiconductor memory, and a programmable logic circuit may be used. Further, the program may be supplied to the computer via any transmission medium (a communication network, a broadcast wave, or the like) able to transmit the program. Note that an aspect of the present disclosure may be implemented in a form of data signal embedded in a carrier wave, which is embodied by electronic transmission of the program.

### SUMMARY

An information processing device (20) according to a first aspect of the present disclosure is an information processing device cooperative with a display device (10) including an antenna (NFC antenna 114) stacked on a display body (display unit 113), and communicable with an information terminal (NFC terminal 100), the information processing device including: an identification information acquisition circuit (terminal information acquisition circuit 211) acquiring identification information stored in the information terminal and identifying the information terminal or a user, from the information terminal via the antenna; a position determination circuit (214) determining whether or not a terminal position being a position where the information terminal comes in proximity to or comes into contact with the display body corresponds to at least one prescribed position determined in advance; and a processing permission circuit (216) permitting prescribed processing in a case where a first condition is satisfied, the first condition being that the identification information acquired by the identification information acquisition circuit satisfies a prescribed condition and the position determination circuit determines that the terminal position corresponds to the prescribed position.

According to the above-described configuration, it is possible to provide a state that prescribed processing is executable only by checking whether or not the identification information stored in an information terminal satisfies a prescribed condition, and whether or not the terminal position corresponds to a prescribed position. Therefore, it is possible to execute various types of processing by means of simple operations and processing.

An information processing device according to a second aspect of the present disclosure is preferably includes, in the first aspect, an authentication circuit (213) performing authentication of the information terminal by using the identification information, as determination processing as to whether or not the identification information acquired by the identification information acquisition circuit satisfies the prescribed condition, wherein the processing permission circuit permits the prescribed processing, in a case where authentication of the information terminal succeeds, and the terminal position corresponds to the prescribed position.

According to the above-described configuration, it is possible to provide a state that prescribed processing is executable in a case where authentication of the information terminal succeeds, and the terminal position corresponds to the prescribed position.

An information processing device according to a third aspect of the present disclosure is preferably configured that, in the first or second aspect, the processing permission circuit permits writing of prescribed information to the information terminal, or permits management of prescribed information associated with the information terminal by a management device (server 30) configured to manage the identification information stored in the information terminal, in a case where the first condition is satisfied.

According to the above-described configuration, it is possible to provide a state in which writing of prescribed information in the information terminal or management of the prescribed information in association with the information terminal by the management device is executable as prescribed processing, in a case where the identification information satisfies the prescribed condition and the terminal position corresponds to the prescribed position.

An information processing device according to a fourth aspect of the present disclosure preferably includes, in the third aspect, an information presence/absence determination circuit (215) determining whether the prescribed information is stored in the information terminal, or is stored in the management device in association with the information terminal, wherein the processing permission circuit determines that the writing or the management is not permitted, in a case where the information presence/absence determination circuit determines that the prescribed information is stored in the information terminal, or is stored in the management device in association with the information terminal, even in a case where the first condition is satisfied.

According to the above-described configuration, in a case where the prescribed information is stored in the information terminal or is stored in the management device in association with the information terminal, it is possible to prevent the above-described writing from execution or the above-described management from execution even in a case where the above-described first condition is satisfied. Therefore, even in a case where the identification information satisfies the prescribed condition and the terminal position corresponds to the prescribed position, it is possible to restrict the prescribed information from being stored a plurality of times in the information terminal or from being stored in the management device in association with the information terminal, as long as the prescribed information is stored. Moreover, such restriction can promote use of the prescribed information to a user for releasing the restriction.

An information processing device according to a fifth aspect of the present disclosure preferably includes, in the third aspect, an information presence/absence determination circuit determining whether the prescribed information is stored in the information terminal or is stored in the management device in association with the information terminal, wherein the processing permission circuit permits the writing or the management, in a case where the first condition is satisfied, and the information presence/absence determination circuit determines that the prescribed information is not stored in the information terminal or is not stored in the management device in association with the information terminal.

According to the above-described configuration, in a case where the above-described first condition is satisfied, and the prescribed information is not stored in the information terminal or is not stored in the management device in association with the information terminal, it is possible to execute the above-described writing or execute the above-described management. In this way. by storing the prescribed information in the information terminal or the management terminal, it is possible to prevent additional writing or management described above from execution. In other words, it is possible to restrict the above-described writing or management from being executed a plurality of times, as long as the prescribed information is stored. Furthermore, even in a case where the prescribed information is stored, it is possible to make the writing executable again in a case where the stored prescribed information is thereafter deleted.

An information processing device according to a sixth aspect of the present disclosure is preferably configured that, in any one of the first to fifth aspect, the display device includes a plurality of the antennas, and at least one of positions of the plurality of the antennas and the at least one prescribed position are associated.

According to the above-described configuration, it is possible to determine whether or not the terminal position corresponds to the prescribed position by identifying the position of the antenna which the information terminal is close to.

An information processing device according to a seventh aspect of the present disclosure is preferably configured that, in any one of the first to sixth aspect, the display device further includes a touch sensor (touch panel 111), and the position determination circuit determines whether or not the terminal position acquired by the touch sensor corresponds to the prescribed position.

According to the above-described configuration, it is possible to determine whether or not the terminal position corresponds to the prescribed position by acquiring the terminal position by the touch sensor. Moreover, it is possible to improve detection accuracy of the terminal position by using the touch sensor.

A display device according to an eighth aspect of the present disclosure includes the information processing device according to any one of the first to seventh aspects.

According to the above-described configuration, it is possible to implement a display device that enables execution of various types of processing by means of simple operations and processing.

A method for controlling an information processing device according to a ninth aspect of the present disclosure is a method for controlling an information processing device cooperative with a display device including an antenna stacked on a display body, and communicable with an information terminal, the method including: an identification information acquisition step of acquiring identification information stored in the information terminal and identifying the information terminal or a user, from the information terminal via the antenna; a position determination step of determining whether or not a terminal position being a position where the information terminal comes in proximity to or comes into contact with the display body corresponds to at least one prescribed position determined in advance; and a processing permission step of permitting prescribed processing in a case where a first condition is satisfied, the first condition being that the identification information acquired by the identification information acquisition step satisfies a prescribed condition and the position determination step determines that the terminal position corresponds to the prescribed position.

According to the above-described method, effects similar to those in the first aspect can be exhibited.

The information processing device according to each aspect of the present disclosure may be implemented by a computer. In this case, an information processing program for the information processing device which causes the computer to function as each unit (software module) included in the information processing device and a computer-readable recording medium storing the information processing program fall within the scope of the present disclosure.

### ADDITIONAL NOTES

The present disclosure is not limited to each of the above-described embodiments. It is possible to make various modifications within the scope of the claims. An embodiment obtained by appropriately combining technical elements each disclosed in different embodiments falls also within the technical scope of the present disclosure. Furthermore, technical elements disclosed in the respective embodiments may be combined to provide a new technical feature.

### REFERENCE SIGNS LIST

1, 2, 3 Information processing system
10 Display device
20 Information processing device
30 Server (management device)
100 NFC terminal (information terminal)
111 Touch panel (touch sensor)
113 Display unit (display body)
114 NFC antenna (antenna)
211 Terminal information acquisition circuit (identification information acquisition circuit)
213 Authentication circuit
214 Position determination circuit
215 Information presence/absence determination circuit
216 Processing permission circuit

1. An information processing device cooperative with a display device including an antenna stacked on a display body, and communicable with an information terminal, the information processing device comprising:
an identification information acquisition circuit acquiring identification information stored in the information terminal and identifying the information terminal or a user, from the information terminal via the antenna;
a position determination circuit determining whether or not a terminal position being a position where the information terminal comes in proximity to or comes into contact with the display body corresponds to at least one prescribed position determined in advance; and
a processing permission circuit permitting prescribed processing in a case where a first condition is satisfied,
the first condition being that the identification information acquired by the identification information acquisition circuit satisfies a prescribed condition and the position determination circuit determines that the terminal position corresponds to the prescribed position.

2. The information processing device according to claim 1, comprising
an authentication circuit performing authentication of the information terminal by using the identification information, as determination processing as to whether or not the identification information acquired by the identification information acquisition circuit satisfies the prescribed condition, wherein
the processing permission circuit permits the prescribed processing, in a case where authentication of the information terminal succeeds, and the terminal position corresponds to the prescribed position.

3. The information processing device according to claim 1, wherein
the processing permission circuit permits writing of prescribed information to the information terminal, or permits management of prescribed information associated with the information terminal by a management device configured to manage the identification information stored in the information terminal, in a case where the first condition is satisfied.

4. The information processing device according to claim 3, comprising
an information presence/absence determination circuit determining whether the prescribed information is stored in the information terminal, or is stored in the management device in association with the information terminal, wherein
the processing permission circuit determines that the writing or the management is not permitted, in a case where the information presence/absence determination circuit determines that the prescribed information is stored in the information terminal, or is stored in the management device in association with the information terminal, even in a case where the first condition is satisfied.

5. The information processing device according to claim 3, comprising
an information presence/absence determination circuit determining whether the prescribed information is stored in the information terminal or is stored in the management device in association with the information terminal, wherein
the processing permission circuit permits the writing or the management, in a case where the first condition is satisfied, and the information presence/absence determination circuit determines that the prescribed information is not stored in the information terminal or is not stored in the management device in association with the information terminal.

6. The information processing device according to claim 1, wherein
the display device includes a plurality of the antennas, and
at least one of positions of the plurality of the antennas and the at least one prescribed position are associated.

7. The information processing device according to claim 1, wherein
the display device further includes a touch sensor, and
the position determination circuit determines whether or not the terminal position acquired by the touch sensor corresponds to the prescribed position.

8. A display device comprising the information processing device according to claim 1.

9. A method for controlling an information processing device cooperative with a display device including an antenna stacked on a display body, and communicable with an information terminal, the method comprising:
an identification information acquisition step of acquiring identification information stored in the information terminal and identifying the information terminal or a user, from the information terminal via the antenna;
a position determination step of determining whether or not a terminal position being a position where the information terminal comes in proximity to or comes into contact with the display body corresponds to at least one prescribed position determined in advance; and
a processing permission step of permitting prescribed processing in a case where a first condition is satisfied,
the first condition being that the identification information acquired by the identification information acquisition step satisfies a prescribed condition and the position determination step determines that the terminal position corresponds to the prescribed position.

10. A non-transitory computer-readable recording medium storing an information processing program causing a computer to function as the information processing device according to claim 1, the information processing program configured to:
cause a computer to function as the identification information acquisition circuit, the position determination circuit, and the processing permission circuit.
